(19) United States
(12) Patent Application Publication
(10) Pub. No.: US 2026/0141468 A1
(43) Pub. Date: May 21, 2026

(54) INTEGRATED COMPLIANT CONSENT CAPTURE SYSTEMS AND METHODS

(71) Applicant: Callpliance, LLC, Riverview, FL (US)

(72) Inventors: Matt Tillman, Riverview, FL (US); Hillary Hobson, Riverview, FL (US); Naomi Harris, Riverview, FL (US)

(73) Assignee: Callpliance, LLC, Riverview, FL (US)

(21) Appl. No.: 18/949,308

(22) Filed: Nov. 15, 2024

(51) Int. Cl. G06Q 50/18

(52) U.S. Cl. CPC G06Q 50/18

(57) ABSTRACT

Embodiments described herein relate to a consumer consent capture system enabling compliant, streamlined management of consumer permissions for communications by securely storing and organizing detailed consent records. This can include capturing consumer consent data, parsing it according to compliance needs, and generating reports that provide clients with insights into consumer engagement and consent trends. Processes and methods include at least a customizable form development tool, allowing clients to design compliant, brand-aligned consent forms with options for adding regulatory disclosures and pre-filled customer data. After consumers initiate contact, custom links are generated and securely transmitted, guiding them through a transparent consent process. Each interaction is meticulously documented, capturing timestamps, device information, and additional metadata for future verification, ensuring alignment with regulations and laws. Integrating smoothly with existing client platforms, this system supports effective, data-driven consent management, helping clients maintain consumer trust and regulatory compliance while optimizing consent capture workflows.

### FIELD

The present disclosure relates to consumer consent capture. More particularly, the present disclosure relates to utilizing an integrated system for capturing consumer consent in accordance with one or more compliance regulations or laws.

### BACKGROUND

Telephone marketing systems have long relied on consumer consent to legally engage in outreach efforts like sales calls, texts, and robocalls. Traditionally, businesses could obtain consent through relatively informal methods, such as verbal agreements over the phone, implied consent from network partner lists, or even referrals from existing customers. These methods allowed companies to reach a broad range of potential customers without needing to document every interaction in detail. However, regulatory bodies have been prompted to tighten the rules around consent. For example, the Telephone Consumer Protection Act (TCPA) in the United States is likely to reshape the legal landscape for telephone marketing, particularly with its emphasis on the use of automated dialing systems and the need for consumer protection.

In response to growing concerns over consumer privacy and the rise of robocalls, regulatory changes are now shifting the requirements for obtaining consent to more stringent, verifiable methods. Old forms of consent like verbal agreements and the use of network partner lists are no longer sufficient. For example, a consumer might not fully understand they are consenting to receive calls from third parties if they agreed verbally or through vague terms buried in a partner's privacy policy. Similarly, referral-based systems, where a consumer's contact information is shared by someone else, are increasingly being viewed as a breach of privacy unless the referred party directly opts in. Under updated regulations, especially with the TCPA and FCC's guidance, businesses must now obtain prior express written consent from consumers, ensuring that they clearly understand who will be contacting them and for what purpose.

These changes make telephone marketing more challenging for businesses, particularly those that have relied heavily on legacy consent practices. Moving forward, companies will need to implement more robust consent-capture mechanisms, such as using online forms with checkboxes or digital signatures, and ensure that consent is explicitly recorded and stored. Complying with the new regulations will be challenging for companies, as they will need to overhaul their consent collection processes to meet stricter requirements for written consent. This shift will require businesses to invest in new technologies, such as third-party consent verification tools and more advanced consumer relationship management systems, to accurately capture, store, and track consumer consent. As a result, companies will face increased operational complexity and costs in order to maintain compliance and avoid penalties under regulations like the TCPA.

### SUMMARY OF THE DISCLOSURE

Systems and methods for utilizing an integrated system for capturing consumer consent in accordance with one or more compliance regulations or laws in accordance with embodiments of the disclosure are described herein.

In some embodiments, a device, includes a processor, a memory communicatively coupled to the processor, and a consent capture logic. The logic can be configured to receive a request for a consumer consent capture, record verbal consent from consumer, generate a custom link transmit a message to the consumer, wherein the message incorporates at least the customized link, receive consent form data associated with the consumer, and generate consent record data.

In some embodiments, the message is a text message.

In some embodiments, the consent capture logic is further configured to store the consent record data.

In some embodiments, the consent record data further includes at least the verbal consent recording.

In some embodiments, the custom link is configured to direct the consumer to a consent form.

In some embodiments, the consent form is associated with a client requesting consent from the consumer.

In some embodiments, the consent form is bespoke for the client.

In some embodiments, the bespoke consent form includes at least client branding.

In some embodiments, the consent capture logic is further configured to transmit the consent record data to the client.

In some embodiments, the request for the consumer consent capture is received from a customer relationship management software.

In some embodiments, the consent record data is configured as prior express written consent.

In some embodiments, the prior express written consent is formatted to comply with one or more legal requirements.

In some embodiments, the one or more legal requirements includes at least the Telephone Consumer Protection Act.

In some embodiments, a method of providing customized consent forms includes gathering client data, determining one or more compliance requirements, parsing the client data for at least client branding, generating at least one bespoke consent form utilizing the client branding and including a plurality of input fields, receiving a request for consumer consent capture, determining at least one input field of the plurality of input fields that can be prefilled, transmitting a custom link to access the bespoke consent form, receiving a request for delivery of the bespoke consent form, and rendering the bespoke consent form with at least one prefilled field.

In some embodiments, the request for consumer consent capture includes at least consumer data.

In some embodiments, the at least one input field is determined by parsing the consumer data.

In some embodiments, the custom link is configured with at least one identifier to indicate association with a particular consumer.

In some embodiments, the rendering of the bespoke consent form is transmitted over a network.

In some embodiments, the client branding includes at least a client logo.

In some embodiments, a method of capturing consent includes receiving a request for a consumer consent capture, recording verbal consent from consumer, generating a custom link transmitting a message to the consumer, wherein the message incorporates at least the customized link, receiving consent form data associated with the consumer, and generating consent record data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a consumer marketing ecosystem in accordance with various embodiments of the disclosure;

FIG. 2 is a conceptual block diagram of a device suitable for configuration with a consent capture logic, in accordance with various embodiments of the disclosure;

FIG. 3 is an abstract block diagram of the components of a consumer consent capture system in accordance with various embodiments of the disclosure;

FIG. 4 is an abstract block diagram of the integration relationships within a storage of a consumer consent capture system in accordance with various embodiments of the disclosure;

FIG. 5 is a conceptual illustration of a consent form generation tool in accordance with various embodiments of the disclosure;

FIG. 6A is a conceptual illustration of a consumer receiving a customized link in accordance with various embodiments of the disclosure;

FIG. 6B is a conceptual illustration of a prior express written consent form in accordance with various embodiments of the disclosure;

FIG. 7 is a conceptual illustration of a plurality of reporting screens in accordance with various embodiments of the disclosure;

FIG. 8 is a process for transmitting a prior express written consent form to a consumer in accordance with various embodiments of the disclosure;

FIG. 9 is a process for capturing prior express written consent in accordance with various embodiments of the disclosure; and

FIG. 10 is a process for providing records from a consumer content capture system in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems outlined above, embodiments of the disclosure described herein can utilize a consumer consent capture system providing a comprehensive process for collecting, managing, and verifying consumer consent for communications, ensuring compliance with data privacy regulations and creating a seamless experience for clients. The consent capture process can begin by generating and securely storing unique consent records for each consumer interaction. These records may include detailed information such as the consumer's contact information, consent type, and metadata like timestamps and IP addresses.

When a client initiates a consent request process, often by initiating contact through an outbound advertisement, the system can generate a custom link sent directly to the consumer's mobile device or email, leading them to a pre-filled consent form. This customized consent form can serve as prior authorized written consent, meeting compliance requirements for various laws and regulations, such as the Telephone Consumer Protection Act (TCPA), among others. The consent form can often be provided with pre-filled information utilized from known consumer data. This streamlined approach minimizes data entry and improves accuracy by leveraging known consumer data. The capture process provides a full audit trail, documenting each step from initial consent request to final written authorization, offering robust protection for both clients and consumers in a regulatory environment.

To ensure compliance and alignment with regulatory requirements, the system can be configured to use carefully structured logics, including consent capture logic, compliance needs, and data retention policies. The consent capture logic may determine the flow of the consent process, adapting it to the type of consent needed, whether for marketing, service updates, or transactional notifications. Compliance data can identify the relevant regulations (like GDPR or TCPA) and incorporates any legal language or required disclosures into the forms automatically. Once consumer consent is given, the system can store these details securely, adhering to data retention policies that ensure records are maintained only as long as legally necessary. These logical frameworks enable the system to adapt flexibly across industries and regions while upholding strict data privacy and security standards, protecting consumer rights and maintaining the integrity of the consent capture process.

In addition to its regulatory foundations, the system uses various data management features to store, parse, and access detailed consent information. Each consumer's consent record can be stored in a secure, encrypted database that clients can access for compliance reviews or report generation. The system's data parsing capabilities may enable it to filter and organize records based on specific criteria, such as consent type, date range, or demographic information, supporting clients in creating targeted reports. Access controls further enhance data security by ensuring only authorized personnel can view or interact with sensitive consent records. Through robust data management, clients gain a high level of transparency and control over their consent capture efforts, supporting internal audits, regulatory reviews, and data-driven decision-making.

To facilitate customization, the system may include tools such as a form development tool, activity log, and customized settings view. The form development tool can allow clients to create branded, compliant consent forms with customizable fields, pre-set regulatory disclosures, and the ability to add elements like checkboxes and dropdown menus for specific types of consent. The activity log can provides a chronological record of all actions taken within the system, such as consent form modifications, submissions, and updates to client settings, offering a clear audit trail that supports compliance and accountability. Meanwhile, the settings view may enable clients to manage user permissions, data retention preferences, and integration settings, creating a customized experience that aligns with each client's operational needs. These customizable components allow clients to shape the consent capture process to meet their specific goals, creating an efficient, user-friendly workflow.

The system's dashboard can act as a central hub where clients can monitor key metrics, access reports, and view real-time updates on consent activity. Through interactive charts and graphs, clients gain immediate insights into consumer engagement, opt-out trends, and consent rates, enabling them to assess the effectiveness of their communication strategies. The dashboard may also link to essential tools like the activity log and form development tool, facilitating easy access to reporting features, form customization, and data retrieval. By providing clients with a comprehensive, intuitive dashboard, the system empowers them to manage, refine, and improve their consent capture processes, ensuring compliance while building trust and engagement with their consumers.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

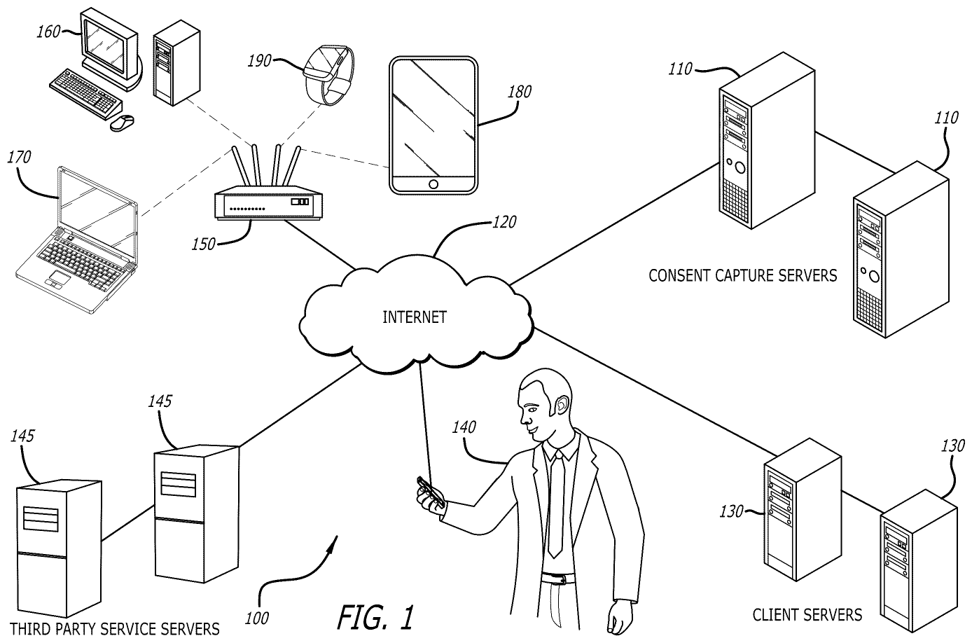

Referring to FIG. 1, a consumer marketing ecosystem 100 in accordance with various embodiments of the disclosure is shown. In many embodiments, a consumer consent capture system can be designed to seamlessly integrate and function across various devices, including consent capture servers 110, client servers 130, third-party service servers 145, consumers, 140, and their related devices such as, laptops 170, personal computers 160, tablets 180, smartphones, wearable devices 190, and more. Communication can be done via one or more networked systems such as, but not limited to, the Internet 120 and wireless systems like those managed by a network router 150, etc. This integration can ensure a consistent and optimized gaming experience, regardless of the device being used.

In many embodiments, the consumer consent capture system can be configured to integrate seamlessly within a larger customer marketing ecosystem, allowing businesses to manage consent efficiently across various platforms and devices while staying compliant with regulations like the TCPA. The system can operate using several components, such as consent capture servers, which may handle the collection and storage of customer consent data, client servers that provide businesses with real-time access to this data, and third-party service servers that could integrate with external verification tools or marketing platforms. These components can work together, enabling businesses to capture and verify consent from consumers, ensuring that interactions may be properly logged and easily retrievable for compliance audits or marketing purposes.

In more embodiments, the system may function across a wide range of consumer devices, including laptops 170, personal computers 160, tablets 180, smartphones, and wearable devices 190. Consumers 140 may be able to access consent capture forms or verification links from any of these devices, providing a flexible and user-friendly experience. In further embodiments, the system can be designed to be cross-platform compatible, meaning whether a consumer uses a mobile phone or a desktop (i.e., a personal computer 160), the interaction may be captured consistently. This could make it easier for businesses to manage a diverse range of customer touchpoints. Additionally, the system might support the integration of third-party services, enabling businesses to incorporate additional layers of verification or tie consent capture into broader marketing automation systems.

In additional embodiments, the system can communicate through various networked systems, including the Internet 120 and wireless networks managed by routers 150, ensuring that data may be securely transferred between the business, third-party services, and consumer devices. Whether the consumer is connected through Wi-Fi, a mobile network, or another wireless system, the consent capture requests and verifications can flow seamlessly across all components. This connectivity may help businesses operate the system at scale, managing consent data in real-time from multiple customers across different devices, while remaining compliant with privacy regulations.

In more embodiments, the consent capture server 110 can act as the central hub where consumer data is collected and stored. When a consumer 140 submits a form or verifies consent via SMS, the consent capture server 110 may communicate with the client server 130, updating the business's internal systems with real-time data. At the same time, third-party service servers 145 might interact with a consent capture server 110 to provide additional verification steps, such as validating the authenticity of the consumer's interaction or cross-referencing with external databases. The client server 130 can allow businesses to monitor and manage these interactions, while third-party servers 145 might provide tools or services that enhance the system's functionality. Together, these servers may ensure that data flows smoothly between all parts of the ecosystem, providing businesses with a compliant and scalable solution for managing consumer consent.

This multi-server interaction could ensure that every component in the system communicates efficiently. For example, the consent capture server 110 may act as the authoritative source for consumer consent, while client servers 13 can pull data from it in real-time to inform marketing decisions. If any discrepancies or further verification is required, third-party servers 145 may step in to validate the captured data or provide additional compliance checks, creating a layered system that supports both operational efficiency and regulatory adherence.

In some embodiments for example, a consent capture server 110 can be in communication with client servers 130 to capture branding data that can be utilized to generate a bespoke consent capture form for that client. In still more embodiments, the third-party service servers 145 can be configured to generate client-based consumer advertising with an inbound phone number. Subsequently, the consumer 140 can be interested in the client product/service can call the phone number in the advertisement. The consumer 140 can be directed by the client (or via the client servers 130) to start a prior express written consent process. The client servers 130 can contact the consent capture servers 110 to start this process.

The consent capture servers 110 can generate a bespoke or otherwise customized consent form which may include data relevant to that client and their consent needs. In more embodiments, the client capture servers 110 can generate a custom link for transmission to the consumer 140 that links back to the bespoke consent form. The consumer can access the bespoke consent form and fill it out, such that once it is filled out it can be construed as prior express written consent. The consent capture servers 110 can store the records related to this consent and associate it with the consumer 140. In some embodiments, the consent capture servers 110 can transmit this consent data to the client servers 130 for further processing. In certain embodiments, the consent capture servers 110 can retain the consent data and transmit an indication or other signal to the client servers 130 that consent was successfully captured, allowing for further marketing to continue with the consumer 140.

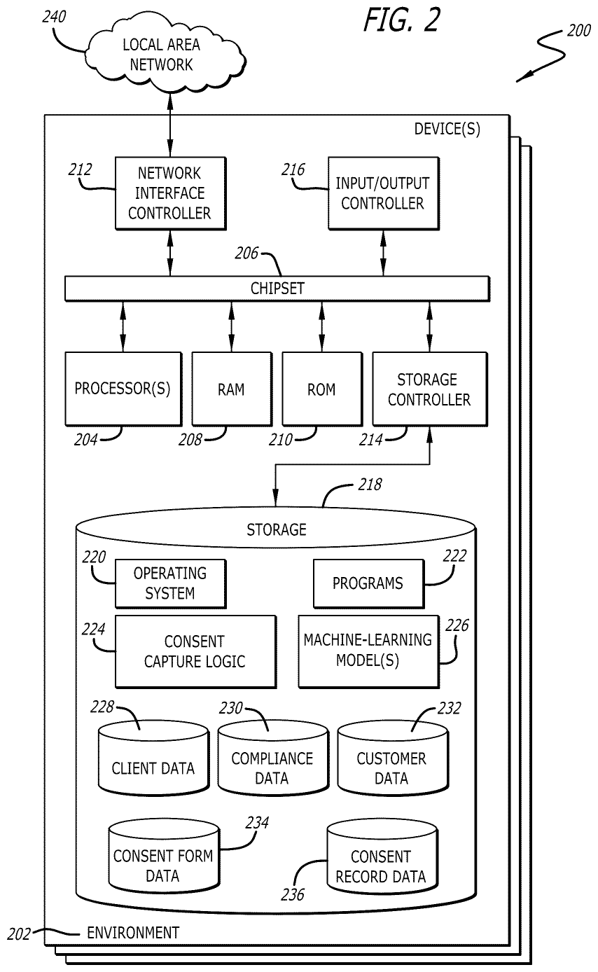

Although a specific embodiment for a consumer marketing ecosystem 100 is described above with respect to FIG. 1, any of a variety of systems and/or processes may be utilized in accordance with embodiments of the disclosure. For example, those skilled in the art will recognize that the client servers 130 and/or consent capture servers 110 can communicate or otherwise utilize one or more third-party servers 145 to access additional resources or tools otherwise not available on the consent capture servers 110 or client servers 130. The elements depicted in FIG. 1 may also be interchangeable with other elements of FIGS. 2-10 as required to realize a particularly desired embodiment.

Referring to FIG. 2, a conceptual block diagram of a device 200 suitable for configuration with a consent capture logic 224, in accordance with various embodiments of the disclosure is shown. The embodiment of the conceptual block diagram depicted in FIG. 2 can illustrate a conventional computing device, personal computer, mobile device, server, laptop, tablet, network appliance, e-reader, smartphone, wearable device, or other computing device, and can be utilized to execute any of the application and/or logic components presented herein. The device 200 may, in many non-limiting examples, correspond to physical devices or to virtual resources described herein.

In many embodiments, the device 200 may include an environment 202 such as a baseboard or “motherboard,” in physical embodiments that can be configured as a printed circuit board with a multitude of components or devices connected by way of a system bus or other electrical communication paths. Conceptually, in virtualized embodiments, the environment 202 may be a virtual environment that encompasses and executes the remaining components and resources of the device 200. In more embodiments, one or more processors 204, such as, but not limited to, central processing units (“CPUs”) can be configured to operate in conjunction with a chipset 206. The processor(s) 204 can be standard programmable CPUs that perform arithmetic and logical operations necessary for the operation of the device 200.

In a number of embodiments, the processor(s) 204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 206 may provide an interface between the processor(s) 204 and the remainder of the components and devices within the environment 202. The device 200 can incorporate different types of processors to enhance performance and efficiency across various tasks. A central processing unit (CPU) can handle primary processing tasks such as logic, AI, and user inputs, while a graphics processing unit (GPU) can be specialized for rendering high-resolution graphics and visual effects. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations, further enhancing the realism and responsiveness of the gaming experience. However, those skilled in the art will recognize that the device 200 can any variety or combination of processor(s) 204 as needed to satisfy the desired application.

The chipset 206 can provide an interface to a random-access memory (“RAM”) 208, which can be used as the main memory in the device 200 in some embodiments. The chipset 206 can further be configured to provide an interface to a computer-readable storage medium such as a read-only memory (“ROM”) 210 or non-volatile RAM (“NVRAM”) for storing basic routines that can help with various tasks such as, but not limited to, starting up the device 200 and/or transferring information between the various components and devices. The ROM 210 or NVRAM can also store other application components necessary for the operation of the device 200 in accordance with various embodiments described herein.

Additional embodiments of the device 200 can be configured to operate in a networked environment using logical connections to remote computing devices and computer systems through a network, such as the local area network 240. The chipset 206 can include functionality for providing network connectivity through a network interface controller (“NIC”) 212, which may comprise a gigabit Ethernet adapter or similar component. The NIC 212 can be capable of connecting the device 200 to other devices over the local area network 240. It is contemplated that multiple NICs 212 may be present in the device 200, connecting the device to other types of networks and remote systems, such as the Internet.

In further embodiments, the device 200 can be connected to a storage 218 that provides non-volatile storage for data accessible by the device 200. The storage 218 can, for instance, store an operating system 220, and/or programs 222. In various embodiments, the storage 218 can be connected to the environment 202 through a storage controller 214 connected to the chipset 206. In certain embodiments, the storage 218 can consist of one or more physical storage units. The storage controller 214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 200 can store data within the storage 218 by transforming the physical state of the physical storage units to reflect the information being stored. The specific transformation of physical state can depend on various factors. Examples of such factors can include, but are not limited to, the technology used to implement the physical storage units, whether the storage 218 is characterized as primary or secondary storage, and the like.

In many more embodiments, the device 200 can store information within the storage 218 by issuing instructions through the storage controller 214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. In some embodiments, the device 200 can further read or access information from the storage 218 by detecting the physical states or characteristics of one or more particular locations within the physical storage units.

In addition to the storage 218 described above, certain embodiments of the device 200 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 200. In some examples, operations performed by a cloud computing network, and or any components included therein, may be supported by one or more devices similar to device 200. Stated otherwise, some or all of the operations performed by the cloud computing network, and or any components included therein, may be performed by one or more devices 200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 218 can store an operating system 220 utilized to control the operation of the device 200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 218 can store other system or application programs and data utilized by the device 200.

In many additional embodiments, the storage 218 or other computer-readable storage media is encoded with computer-executable instructions which, when loaded into the device 200, may transform it from a general-purpose computing system into a special-purpose computer capable of implementing the embodiments described herein. These computer-executable instructions may be stored as application and transform the device 200 by specifying how the processor(s) 204 can transition between states, as described above. In some embodiments, the device 200 has access to computer-readable storage media storing computer-executable instructions which, when executed by the device 200, perform the various processes described above with regard to FIGS. 1 and 3-10. In certain embodiments, the device 200 can also include computer-readable storage media having instructions stored thereupon for performing any of the other computer-implemented operations described herein.

In many further embodiments, the device 200 may include a control consent capture logic 224. The consent capture logic 224 can be configured to perform one or more of the various steps, processes, operations, and/or other methods that are described above. Often, the consent capture logic 224 can be a set of instructions stored within a non-volatile memory that, when executed by the processor(s) 204 (or controllers, etc.) can carry out these steps, etc. In some embodiments, the consent capture logic 224 may be a client application that resides on a network-connected device, such as, but not limited to, a server, switch, personal or mobile computing device in a single or distributed arrangement.

In some embodiments, client data 228 may encompass a variety of information tailored to the specific needs of the company using the consent capture system. For instance, this data can include branding elements such as logos, color schemes, and specific messaging that can be used to create customized or bespoke consent forms, ensuring the forms align with the company's identity and provide a seamless consumer experience. In addition to branding, client data 228 may also contain regulatory information detailing the specific consent requirements the company must meet. This could involve compliance with laws such as the Telephone Consumer Protection Act (TCPA), the General Data Protection Regulation (GDPR), or the California Consumer Privacy Act (CCPA), and may dictate how consent must be captured, stored, and managed. The system can also accommodate various regulatory constraints, ensuring that the consent forms, verification processes, and consent storage align with the relevant legal frameworks to which the client is subject. Furthermore, client data 228 may include customer segmentation details, enabling the system to dynamically adjust the consent process based on different consumer demographics, regions, or marketing preferences, ensuring that the consent request is appropriately customized for each targeted audience.

In more embodiments, compliance data 230 may comprise various elements that ensure a company's marketing activities align with relevant laws and regulations. This data can include information about the specific legal requirements the company must follow, such as documentation related to the Telephone Consumer Protection Act (TCPA), the General Data Protection Regulation (GDPR), or the California Consumer Privacy Act (CCPA). Compliance data 230 may also store records of when and how consent was obtained, including time-stamped records of form submissions or SMS verifications, which can be used as proof if a dispute arises about whether proper consent was given. Additionally, compliance data 230 can contain records of any consumer opt-outs or changes to their consent preferences, ensuring that businesses accurately respect and implement these updates. The system may also track consent expiration dates or requirements for re-verification based on specific regulations, helping the company stay up to date with ongoing compliance obligations.

In various embodiments, customer data 232 may encompass a range of information that allows businesses to engage with consumers in a personalized and compliant manner. This data can include basic contact information such as names, email addresses, phone numbers, and mailing addresses, which are necessary for communication and outreach efforts. Additionally, customer data 232 may contain details about customer preferences, such as communication methods they prefer (SMS, email, phone calls) or the types of marketing content they have expressed interest in receiving. The system can also store records of previous interactions with the customer, including any prior consent given, purchases made, or services requested, which may help tailor future communications more effectively.

Beyond preferences, customer data 232 may also include demographic details like age, location, and gender, which can be useful for targeted marketing efforts. The system may track behavioral data, such as website visits or engagement with past campaigns, enabling businesses to refine their marketing strategies based on customer behavior. Furthermore, customer data 232 may capture consent information, showing when, where, and how the customer gave permission to be contacted, along with any updates or withdrawals of consent.

In various embodiments, consent form data 234 may comprise various elements that enable businesses to capture consent from consumers in a streamlined and compliant manner. The consent forms are typically generated and delivered digitally, often through a custom link that the consumer accesses on their device, such as a smartphone, tablet, or computer. This data can include pre-filled fields populated with already known customer data 232, such as the consumer's name, email address, phone number, and other relevant contact information. By using this pre-filled data, the form can reduce the burden on the consumer, ensuring they can quickly review and confirm or update the information before providing their consent. The consent form data 234 may also include the specific terms and conditions related to the type of communication the business is requesting consent for, such as marketing emails, text messages, or phone calls. This data can further capture any regulatory notices or disclosures that are legally required based on the relevant jurisdiction, ensuring that consumers are fully informed before they give their consent. Additionally, the system may log metadata associated with the form submission, such as the date and time the form was accessed, the device and browser used, and the location of the consumer when they completed the form. This metadata can provide valuable context for compliance tracking and verification purposes.

In still more embodiments, consent record data 236 within the system may comprise the detailed documentation of a consumer's consent, serving as a critical element in demonstrating compliance with relevant laws and regulations. This data can include a time-stamped record of when the consent was obtained, capturing the exact date and time a consumer agreed to be contacted or marketed to. It may also store the method through which the consent was given, such as through a digital form, SMS verification, or an email confirmation. Additionally, consent record data 236 may contain a digital copy of the consent form that was presented to the consumer, including the terms and conditions they agreed to, ensuring that there is a clear and verifiable trail of the agreement. The system can also capture metadata such as the IP address, device type, and browser used during the submission of the consent, adding another layer of verification regarding the authenticity of the consent. If the consumer later changes their consent preferences, such as opting out of communications or updating the scope of their consent, the system may log these changes as well, creating a complete and evolving record of the consumer's consent history.

In still further embodiments, the device 200 can also include one or more input/output controllers 216 for receiving and processing input from a number of input devices, such as a keyboard, a mouse, a touchpad, a touch screen, an electronic stylus, or other type of input device. Similarly, an input/output controller 216 can be configured to provide output to a display, such as a computer monitor, a flat panel display, a digital projector, a printer, or other type of output device. Those skilled in the art will recognize that the device 200 might not include all of the components shown in FIG. 2 and can include other components that are not explicitly shown in FIG. 2 or might utilize an architecture completely different than that shown in FIG. 2.

As described above, the device 200 may support a virtualization layer, such as one or more virtual resources executing on the device 200. In some examples, the virtualization layer may be supported by a hypervisor that provides one or more virtual machines running on the device 200 to perform functions described herein. The virtualization layer may generally support a virtual resource that performs at least a portion of the techniques described herein.

Finally, in numerous additional embodiments, data may be processed into a format usable by one or more machine-learning models 226 (e.g., feature vectors), and or other pre-processing techniques. The machine-learning (“ML”) models 226 may be any type of ML model, such as supervised models, reinforcement models, and/or unsupervised models. The ML models 226 may include one or more of linear regression models, logistic regression models, decision trees, Naïve Bayes models, neural networks, k-means cluster models, random forest models, and/or other types of ML models 226.

The ML model(s) 226 can be configured to generate inferences to make predictions or draw conclusions from data. An inference can be considered the output of a process of applying a model to new data. This can occur by learning from at least the client data 228, compliance data 230, customer data 232, consent form data 234, and/or consent record data 236. These predictions can be based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a set of coordinates within a three-dimensional space, a probability distribution, a set of labels/characteristics/parameters, a decision about an action to take, etc. Ground truth for the ML model(s) 226 may be generated by human/administrator verifications or may compare predicted outcomes with actual outcomes.

Although a specific embodiment for a conceptual block diagram of a device suitable for configuration with a consent capture logic suitable for carrying out the various steps, processes, methods, and operations described herein is discussed with respect to FIG. 2, any of a variety of systems and/or processes may be utilized in accordance with embodiments of the disclosure. For example, the device 200 may be in a virtual environment such as a cloud-based administration environment, or it may be distributed across a variety of network devices or servers. The elements depicted in FIG. 2 may also be interchangeable with other elements of FIGS. 1 and 3-10 as required to realize a particularly desired embodiment.

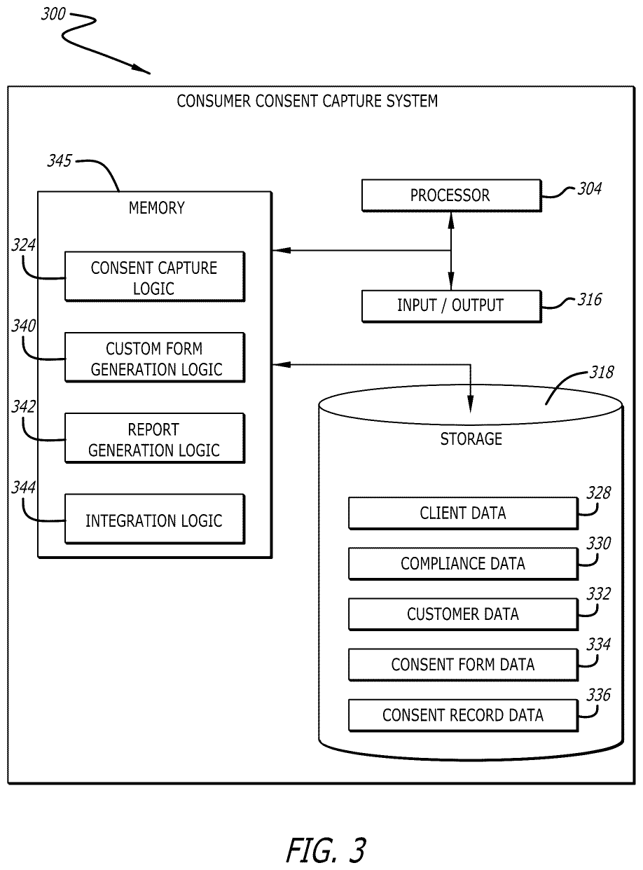

Referring to FIG. 3, an abstract block diagram of the components of a consumer consent capture system 300 in accordance with various embodiments of the disclosure is shown. In many embodiments, the consumer consent capture system 300 can be configured to include at least one or more processors 304, input/output functionality 316, a storage 318 as well as a memory 345 configured for executing one or more various logics. Specifically in the embodiment depicted in FIG. 3, the memory 345 comprises a consent capture logic 324 as well as a custom form generation logic 340, report generation logic 342, and an integration logic 344. Similarly, the storage 318 may comprise client data 328, compliance data 330, customer data 332, consent form data 334, and consent record data 336.

In some embodiments, consent capture logic 324 may comprise the set of rules and processes that govern how consumer consent is collected, verified, and stored to ensure compliance with various legal and regulatory frameworks. This logic can determine how the consent forms are generated, including which customer data is pre-filled, what regulatory disclosures must be displayed, and how the form adapts based on the consumer's location, preferences, or the type of consent being requested. The consent capture logic 324 may also handle conditional workflows, such as presenting different consent options depending on whether the consumer is engaging with the business for marketing purposes, service updates, or both. The system can use this logic to manage the timing and frequency of consent requests, ensuring that consumers are not overloaded with repeated prompts but that their consent remains up to date. Additionally, consent capture logic 324 may include automated triggers for sending verification links, such as through SMS or email, and rules for how long a link remains valid before expiration. This logic could also specify how to handle cases where consent is partially given or if the consumer withdraws consent at a later stage, ensuring that these changes are immediately reflected in the system's records. In a number of embodiments, these logics may be configured as separate logics or may be interconnected or packaged/executed as a single logic.

In many embodiments, custom form generation logic 340 may comprise the rules and algorithms that dictate how personalized consent forms are created and tailored to individual consumers based on specific criteria. This logic can pull from existing customer data, such as names, contact information, and preferences, to pre-fill fields on the consent forms, minimizing the effort required from the consumer and ensuring accuracy. Additionally, custom form generation logic 340 may adapt the content of the form based on the regulatory requirements applicable to the consumer's location, such as including specific legal disclosures for compliance with the Telephone Consumer Protection Act (TCPA), General Data Protection Regulation (GDPR), or California Consumer Privacy Act (CCPA).

The logic can also be designed to include or exclude certain form fields depending on the type of consent being requested, such as whether the consumer is agreeing to receive marketing communications, service updates, or both. Furthermore, custom form generation logic 340 may take into account branding elements provided by the client, including logos, color schemes, and fonts, ensuring that the form aligns with the company's visual identity while maintaining a professional and trustworthy appearance. This logic could also be configured to generate forms dynamically based on the consumer's device, ensuring optimal display and usability whether accessed on a smartphone, tablet, or desktop. By utilizing these capabilities, custom form generation logic may ensure that consent forms are not only compliant with legal standards but also user-friendly and tailored to each consumer's specific context and needs.

In a number of embodiments report generation logic 342 may comprise the processes and algorithms responsible for creating detailed reports that provide insights into how the consent capture system is functioning. In various embodiments, this logic can pull data from various sources within the system, such as consent records, customer data 332, and compliance tracking, to generate visual representations in the form of dashboards, charts, graphs, and other user-friendly interfaces. These reports may be tailored to meet the needs of the client, displaying metrics such as the number of consent forms sent, the rate of successful consent capture, or the number of consent withdrawals over time. The logic can also allow clients to filter and segment data by specific parameters, such as date ranges, geographic locations, or consumer demographics, to gain more detailed insights into their consent capture performance.

In certain embodiments, the report generation logic 342 may also provide real-time updates, enabling clients to view live data on their system's performance and make adjustments as needed. It can generate periodic reports automatically, offering a comprehensive overview of how the consent capture process aligns with regulatory requirements and marketing goals. Additionally, the logic may support customizable GUIs (graphical user interfaces), allowing clients to design their own dashboards based on the key performance indicators that are most relevant to their business. Through these various reporting tools, the report generation logic can help businesses not only monitor their compliance and consent capture rates but also optimize their outreach strategies based on the insights gathered from the data.

The logic can also be designed to include or exclude certain form fields depending on the type of consent being requested, such as whether the consumer is agreeing to receive marketing communications, service updates, or both. Furthermore, custom form generation logic 342 may take into account branding elements provided by the client, including logos, color schemes, and fonts, ensuring that the form aligns with the company's visual identity while maintaining a professional and trustworthy appearance. This logic could also be configured to generate forms dynamically based on the consumer's device, ensuring optimal display and usability whether accessed on a smartphone, tablet, or desktop.

In yet more embodiments, integration logic 344 may comprise the set of rules and protocols that enable the consent capture system to communicate and work seamlessly with various third-party servers or platforms. This logic can allow the system to integrate with external tools such as dialers, communication platforms, and CRM software suites, ensuring that data flows smoothly between systems and is updated in real-time. For example, when a consumer's consent is captured, the integration logic may automatically update the client's CRM software to reflect the new consent status, enabling sales and marketing teams to proceed with communications while staying compliant with regulations. Similarly, integration logic 344 may link the system to communication platforms, enabling SMS or email verification links to be sent directly from the system based on predefined workflows.

Additionally, the system can integrate with record hygiene systems, such as do-not-call lists or opt-out databases, to ensure that outreach efforts avoid consumers who have not given consent or have explicitly withdrawn it. Integration logic 344 may also support connections with automation systems, enabling the consent capture process to trigger follow-up actions like generating reports, updating compliance records, or initiating specific marketing campaigns based on the consent status. The logic could also be configured to manage complex interactions between multiple integrated platforms, such as ensuring data synchronization across different departments or verifying that a dialer only contacts individuals who have provided express consent. By enabling these integrations, the system may enhance operational efficiency and compliance, allowing businesses to manage consent and communication efforts more effectively while leveraging their existing technology stack.

As discussed above in the embodiment depicted in FIG. 2, the consumer consent capture system 300 may include a number of different types of available data to work with. These data may include client data 328, compliance data 330, customer data 332, consent form data 334 and consent record data 336. These various data sources can be similar to the data sources discussed in relation to FIG. 2 above.

Although a specific embodiment for an abstract block diagram of the components of a consumer consent capture system 300 suitable for carrying out the various steps, processes, methods, and operations described herein is discussed with respect to FIG. 3, any of a variety of systems and/or processes may be utilized in accordance with embodiments of the disclosure. For example, the memory 345 can be an active memory that has the logics loaded/configured and is currently executing the various steps, processes, and/or methods described herein. In some embodiments, the memory 345 may be in a virtual environment such as a cloud-based system environment, or it may be distributed across a variety of network devices or servers. The elements depicted in FIG. 3 may also be interchangeable with other elements of FIGS. 1-2 and 4-10 as required to realize a particularly desired embodiment.

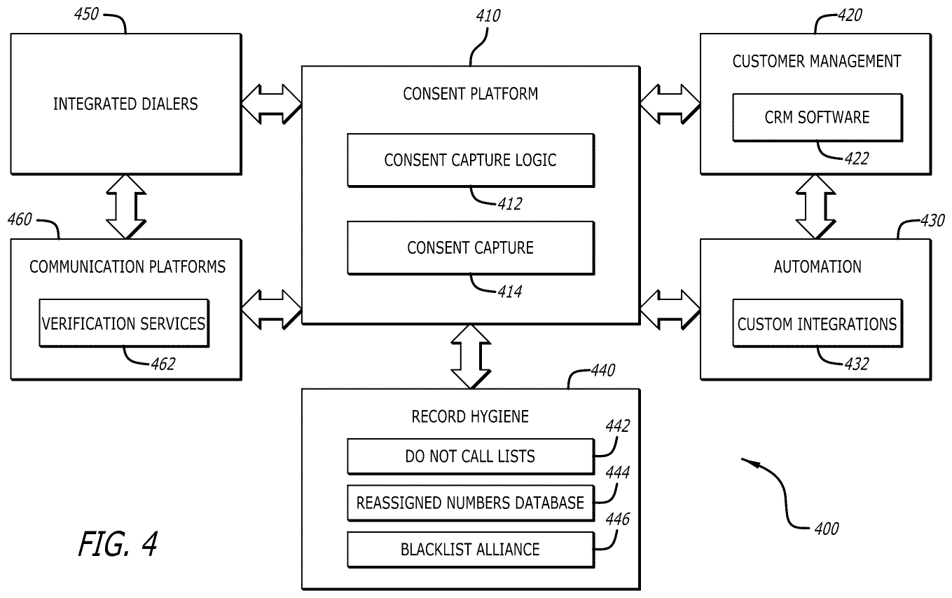

Referring to FIG. 4, an abstract block diagram of the integration relationships 400 within a storage of a consumer consent capture system in accordance with various embodiments of the disclosure is shown. In the embodiment depicted in FIG. 4, a consent platform 410 is interconnected with customer management systems 420, automation systems 430, record hygiene systems 440, integrated dialer systems 450, and communication platforms 460. Each of these systems may themselves be interconnected in various ways.

In many embodiments, the consent platform 410 may comprise at least a consent capture logic 412 and/or a consent capture system 414. A consent platform 410 may comprise a comprehensive framework designed to manage the end-to-end process of capturing, verifying, and storing consumer consent across various communication channels and platforms. In some embodiments, the platform can integrate a consent capture system 414, which handles the collection of consumer consent through digital forms, SMS verification, email confirmations, or other methods. The consent capture logic 412 embedded within the platform can dictate how these consent requests are structured, ensuring that they are compliant with relevant regulations, such as the Telephone Consumer Protection Act (TCPA) or the General Data Protection Regulation (GDPR). This logic may determine how consent forms are generated, how pre-filled customer data is handled, and how different consent options are presented based on the consumer's location or preferences.

Furthermore, the consent platform 410 may incorporate advanced security features to protect sensitive customer information and ensure that consent records are stored securely in accordance with data protection regulations. This can include encryption, secure access controls, and audit trails that document every interaction with the consent data. By integrating all these components, the consent platform system can provide businesses with a robust, scalable solution for managing consumer consent, ensuring compliance with regulatory requirements while streamlining consumer interactions across digital channels.

In a number of embodiments, the customer management system 420 may comprise one or more instances of Customer relationship management (CRM) software 422. CRM software 422 may be a component of the customer management system 420, serving as the central hub for storing and organizing customer data. CRM software 422 can provide businesses with a range of tools to track interactions with customers, including contact history, preferences, and engagement with past marketing efforts. In certain embodiments, the CRM software 422 may be used to store and update consent data directly from the consent capture system, ensuring that all customer interactions comply with the latest consent status. This software may also allow businesses to automate outreach campaigns, ensuring that communications are only sent to consumers who have provided prior express written consent, as required by regulations such as the Telephone Consumer Protection Act (TCPA) or the General Data Protection Regulation (GDPR). CRM software 422 can also integrate with analytics tools to help businesses measure the effectiveness of consent-driven marketing strategies, providing insights into customer behavior, consent expiration, or withdrawal trends, all while maintaining a robust audit trail for compliance purposes.

In more embodiments the customer management system 420 may further be configured to be interconnected with a various other systems to create a seamless flow of data between consumer consent records and broader customer management activities. This integration can allow the customer management system 420 to automatically update and reflect the status of consent for each consumer, ensuring that marketing, sales, and service teams have accurate and real-time information about who can be contacted and through which channels. The interconnected nature of these systems may also enable the customer management system 420 to retrieve consent information whenever a new customer interaction occurs, preventing outreach to individuals who have not provided proper consent. Additionally, the customer management system 420 may leverage consent data to segment customer audiences based on their communication preferences, ensuring targeted and compliant marketing efforts. This connection between the consent platform and the customer management system can streamline processes such as sending reminders, managing preferences, and executing marketing campaigns, as all data flows smoothly between the two systems.

In further embodiments, the automation systems 430 may include one or more custom integration components 432. The custom integrations component 432 of the automation system 430 may serve as a flexible and powerful feature that enables businesses to tailor the system to their specific operational needs by connecting it with various third-party tools and platforms. This component can be used to integrate the consent capture system, customer management system, and automation workflows with external software that may not be natively supported, allowing businesses to extend the functionality of their system. For instance, businesses may use this custom integration feature to connect specialized analytics platforms that provide deeper insights into consumer behavior and consent patterns, or to integrate with industry-specific tools like customer loyalty programs or external lead management systems, enabling data to flow seamlessly between platforms.

In addition to expanding functionality, the custom integrations component 432 may, in certain embodiments, help create specialized workflows for tasks such as marketing automation, sales engagement, or compliance tracking. For example, a business might set up custom triggers that alert customer service teams when a consent withdrawal is detected in the system or automatically generate and send detailed reports to compliance officers based on the latest consent activity. This component may also be used to connect with external communication tools, such as email marketing platforms or SMS gateways, enabling businesses to automate outreach while ensuring compliance with updated consent records. By allowing businesses to create unique integrations with tools they already rely on, the custom integration component can provide flexibility and scalability, ensuring the system remains adaptable to changing business requirements, new regulations, or evolving marketing strategies.

In additional embodiments, the automation system 430 may further include integration with the consent platform 410, customer management system 420, and other components that can serve as a powerful tool for streamlining and automating complex workflows across these interconnected systems. This automation system 430 may handle tasks such as automatically triggering consent requests, sending verification messages, updating customer records in real-time, and ensuring that all customer interactions comply with the latest consent data. For instance, when a customer interacts with communication platforms 460 or integrated dialer systems 450, the automation system 430 can verify in real-time whether the customer has provided the necessary consent, preventing non-compliant communications. Similarly, the automation system 430 may coordinate with the record hygiene system 440 to ensure that all outreach efforts adhere to do-not-call lists or opt-out databases, automatically flagging records that require special handling. The automation system 430 can also streamline marketing campaigns by dynamically adjusting the audience based on consent status, making sure that messages are only sent to customers who have agreed to receive them.

In addition to its core automation functions, this system may feature a custom integrations component 432, allowing businesses to connect it with additional third-party tools and services based on their specific needs. This customization may extend to integrating with specialized analytics platforms, external marketing systems, or other enterprise tools that further enhance the automation process. For example, businesses may create custom workflows that trigger specific actions, such as notifying sales teams when a customer consents to a follow-up call or generating reports when certain consent thresholds are met. The custom integrations component 432 can ensure that the automation system is flexible and adaptable, allowing businesses to scale and evolve their consent and communication processes as their requirements change. With its ability to seamlessly interact with the record hygiene system 440, communication platforms 460, and integrated dialer systems 450, this automation system 430 may ensure that all aspects of consent management, customer engagement, and compliance operate in harmony, significantly improving efficiency and regulatory adherence.

In still more embodiments, the record hygiene system 440 may comprise at least one of do not call lists 442, a reassigned numbers database 444, or data related to a blacklist alliance 446. A record hygiene system 440 can play a role in maintaining the accuracy, compliance, and cleanliness of customer data across the entire ecosystem. This system may continuously scan and update records to ensure that they meet regulatory standards and reflect the latest consumer preferences, such as opt-ins, opt-outs, or do-not-call (DNC) list status. By integrating with the consent capture system 414, the record hygiene system can automatically check that every outreach is compliant with the consent status of each individual, preventing any communication that could lead to regulatory violations. This integration may also ensure that duplicate records, outdated information, or invalid contact details are regularly cleansed, keeping the customer database up-to-date and reducing the risk of wasted outreach efforts or legal complications.

In this interconnected setup, the record hygiene system 440 can also coordinate with the automation system to trigger specific actions based on record updates. For example, if a consumer's phone number is added to a DNC list 442 or if they revoke consent via a withdrawal form, the system can automatically flag that record and notify relevant systems, such as the integrated dialer systems 450 or communication platforms 460, to prevent further outreach. Additionally, it may support custom rules that automatically purge outdated or inactive consent records after a certain period, in accordance with regulations like the General Data Protection Regulation (GDPR) or the Telephone Consumer Protection Act (TCPA). The record hygiene system 440 can also be used to sync with external hygiene services, ensuring the client's data is cross-referenced with industry-standard databases for further accuracy.

In more additional embodiments, the integrated dialer system 450 can be configured to serve as a component in automating and streamlining customer outreach, particularly in environments where high volumes of calls need to be managed efficiently. This system may work in tandem with the consent capture system 414, customer management system 420, and automation system 430 to ensure that all outbound calls are compliant with consumer consent preferences and regulatory requirements, such as those stipulated by the Telephone Consumer Protection Act (TCPA). By integrating with the broader ecosystem, the dialer system can automatically cross-reference customer records to confirm that only those who have provided prior express written consent are contacted, reducing the risk of violations and ensuring a seamless, compliant marketing or customer service strategy.

In addition to its compliance functions, the integrated dialer system 450 can offer sophisticated call management features such as predictive dialing, which may increase call efficiency by automatically dialing numbers and connecting available agents when a customer answers. It may also integrate with customer data stored in the CRM software 422 to allow agents to access relevant information during calls, enhancing personalization and improving customer interactions. This system can further coordinate with the record hygiene system 440, ensuring that any contact information flagged as invalid or listed on do-not-call (DNC) lists 442 is filtered out before calls are made. By automating these processes, the integrated dialer system 450 may not only boost productivity but also ensure that outreach efforts are aligned with both business objectives and consumer preferences. Through its integration with the other components of the ecosystem, the dialer system can enable businesses to manage large-scale customer contact campaigns with increased precision, compliance, and effectiveness.

In numerous embodiments, the communication platforms 460 can include one or more verification services 462. Verification services 462 can be a part of the communication platforms 460 integrated into the broader consent management ecosystem, ensuring that consumer consent is properly verified before any outreach is initiated. These services may function by sending automated verification requests to consumers, typically through multiple communication channels such as SMS, email, or app notifications, depending on their preferences and the methods they consented to. For instance, after a consumer submits a consent form, the verification services 462 may trigger an SMS or email with a custom link for the consumer to confirm their consent. This extra step can provide a more robust layer of compliance, ensuring that the consent is both explicit and properly documented in line with regulatory requirements such as the Telephone Consumer Protection Act (TCPA) or General Data Protection Regulation (GDPR).

The verification services 462 can also integrate with other systems, such as the consent capture logic, to ensure that the verification requests align with the specific consent types the consumer is granting whether for marketing emails, phone calls, or text messages. Additionally, these services can generate time-stamped records of when and how consent was verified, logging details such as the consumer's device, IP address, and geographic location, which may be crucial in the event of a compliance audit or legal dispute. These verification steps can prevent unauthorized or fraudulent consent, providing a higher level of data integrity and consumer trust. By being integrated into the communication platform, verification services 462 can also automate follow-up processes, such as resending verification requests if the initial attempt fails or if there is a delay in response. Ultimately, verification services 462 of the communication platforms 460 can provide a critical safeguard, ensuring that businesses adhere to legal standards while enhancing the transparency and accuracy of their consumer interactions.

In further additional embodiments, the communication platforms 460 may also be configured to The communication platforms 460 can serve as a central hub for managing all consumer interactions across multiple channels, ensuring that outreach efforts are aligned with consumer preferences and consent records. These platforms may integrate seamlessly with the consent capture system, customer management system, automation tools, and verification services, creating a unified environment where businesses can initiate and track communications in a compliant and efficient manner. The communication platforms 460 can support a wide range of outreach methods, including SMS, email, phone calls, and even in-app notifications, depending on how the consumer has opted to be contacted. By leveraging these diverse communication methods, businesses may enhance their engagement strategies, ensuring they reach consumers in their preferred format while adhering to regulatory guidelines such as the Telephone Consumer Protection Act (TCPA) and General Data Protection Regulation (GDPR).

Through integration with the consent capture system 414, the communication platforms 460 can ensure that only consumers who have provided valid consent are contacted, automatically referencing the most up-to-date consent data before any message or call is initiated. This may help businesses avoid sending unwanted communications, reducing the risk of penalties while improving customer satisfaction. Additionally, the platforms can integrate with the record hygiene system 440 to filter out invalid or outdated contact information and ensure that do-not-call lists 442 are respected. Customization features within these platforms may allow businesses to personalize messages based on consumer data stored in the customer management system, enhancing the relevance and effectiveness of each outreach effort. Furthermore, the communication platforms 460 can track and log each interaction, generating reports and analytics that provide insight into engagement rates, message effectiveness, and overall campaign performance.

Although a specific embodiment for an abstract block diagram of the integration relationships 400 within a storage of a consumer consent capture system suitable for carrying out the various steps, processes, methods, and operations described herein is discussed with respect to FIG. 4, any of a variety of systems and/or processes may be utilized in accordance with embodiments of the disclosure. For example, the specific depiction on interconnectedness between the various systems shown is meant to be exemplary and not limiting. Those skilled in the art will recognize that any systems may be interconnected depending on the specific systems being deployed. The elements depicted in FIG. 4 may also be interchangeable with other elements of FIGS. 1-3 and 5-10 as required to realize a particularly desired embodiment.

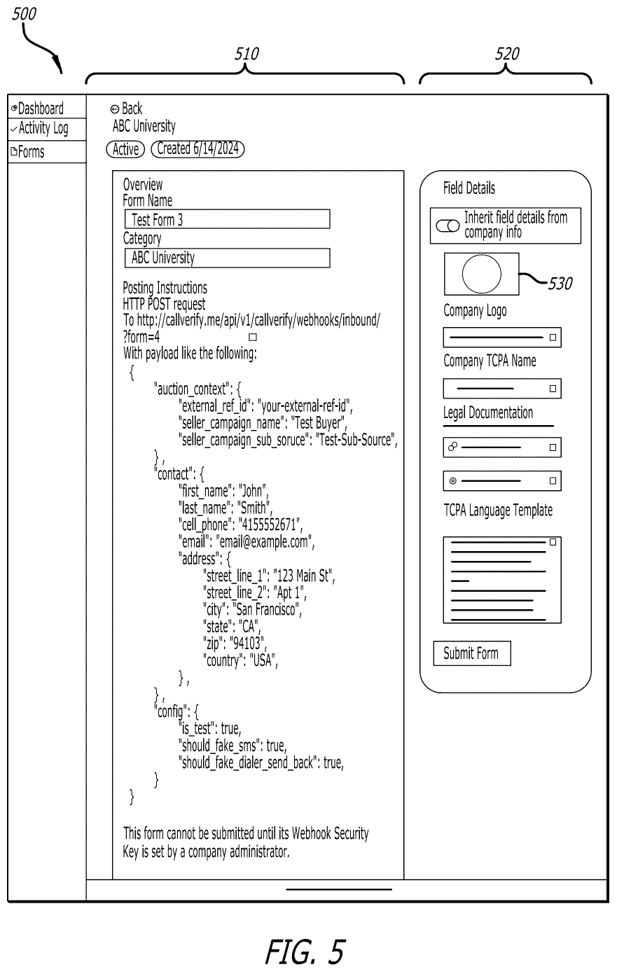

Referring to FIG. 5, a conceptual illustration of a consent form generation tool 500 in accordance with various embodiments of the disclosure is shown. In many embodiments, clients or representatives from a consent capture service may be tasked with generating a customized or bespoke consumer consent form. Such a bespoke consent form 520 is shown in the embodiment of FIG. 5. The customization can be achieved in a variety of ways. The embodiment depicted in FIG. 5 depicts a customized company logo 530 which can be received from the client as branding data. While the consent form generation tool 500 depicts the layout of a mobile phone consent form, it is contemplated that any type of delivery method could be utilized to generate a consent form.

In further embodiments, the consent form generation tool 500 can include an editor section 510. For example, a WYSIWYG (What You See Is What You Get) editor for creating consent forms may provide clients with a user-friendly interface that allows them to design and customize forms across multiple platforms, such as phone, web, or mobile apps, without needing extensive coding skills. In various embodiments, the editor section 510 can offer drag-and-drop functionality, allowing users to add or remove elements like text fields, checkboxes, radio buttons, and dropdown menus, ensuring that each form meets specific regulatory and business requirements. The WYSIWYG editor may also allow for real-time previewing of the form's appearance on different devices, such as smartphones, tablets, and desktops, ensuring that the user experience is consistent and optimized regardless of the platform. Clients can customize the look and feel of the form, applying their company's branding elements such as logos, colors, and fonts, while also ensuring that legal disclosures and consent options are clear and accessible. Additionally, in some embodiments, the editor section 510 may integrate with the consent capture logic, automatically inserting required fields and regulatory language based on the consumer's location or the type of consent being requested. This streamlined, visual approach to form creation can help businesses build compliant, professional forms that are easily deployable across a variety of communication channels.

Although a specific embodiment for a consent form generation tool suitable for carrying out the various steps, processes, methods, and operations described herein is discussed with respect to FIG. 5, any of a variety of systems and/or processes may be utilized in accordance with embodiments of the disclosure. For example, those skilled in the art will recognize that the consent form generation tool 500 can be provided in a variety of layouts and the specific layout in the embodiment of FIG. 5 is just one example. The elements depicted in FIG. 5 may also be interchangeable with other elements of FIGS. 1-4 and 6A-10 as required to realize a particularly desired embodiment.

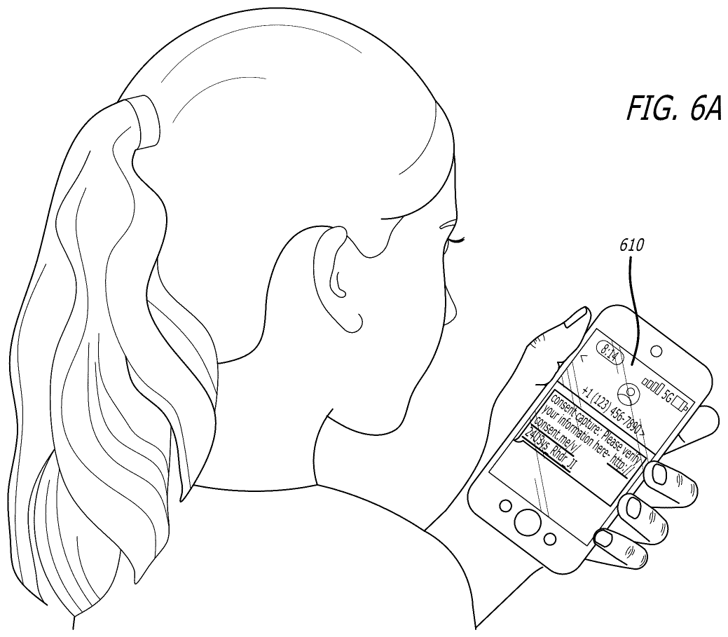

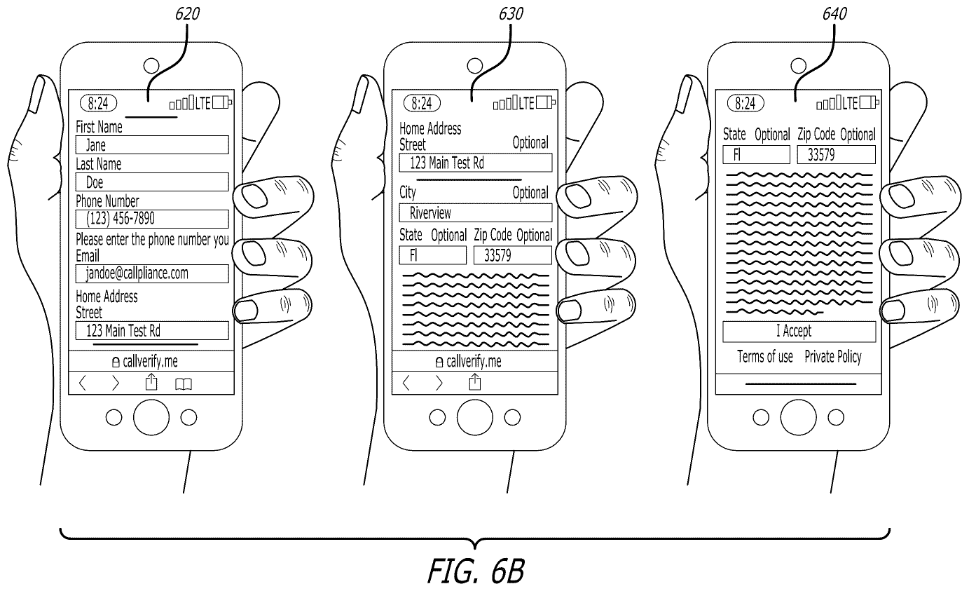

Referring to FIG. 6A a conceptual illustration of a consumer receiving a customized link 610 in accordance with various embodiments of the disclosure is shown. When the consumer receives the text message titled “consent capture: Please verify your information here,” it appears as a clear, straightforward message that includes a customized link 610. The sender is typically a business the consumer recognizes, helping establish a sense of trust and assurance about the message's legitimacy. By briefly stating the purpose as “information verification,” or something similar, the text can provide transparency, helping the consumer understand why they're being contacted. Receiving this on their mobile device makes it convenient for the consumer to engage quickly without switching to a different device or application, enhancing accessibility and ease of interaction. The transparent and concise nature of the text also enhances the consumer's willingness to proceed, feeling assured that their data and preferences are being respected and managed responsibly.

Referring to FIG. 6B, a conceptual illustration of a prior express written consent form in accordance with various embodiments of the disclosure is shown. When the consumer clicks the customized links, such as the one depicted in FIG. 6A, a first written consent form screen 620 may be displayed on their mobile device. In many embodiments, the consumer can see a well-organized layout with their basic information, such as first name, last name, phone number, and email address, already pre-filled. This pre-filled information can streamline the experience, allowing the consumer to review rather than manually enter repetitive details. The mobile-responsive design ensures that each field is clearly visible, legible, and properly aligned with the screen size, making the interaction user-friendly and intuitive. The form's design likely includes a customized and/or branded logo and layout that indicates that the form is from the client. The design may also include readable font sizes, large, tappable fields, and a structured layout that fits naturally within the mobile screen, minimizing the need for scrolling. Seeing familiar information pre-filled may give the consumer confidence in the process, signaling that the business respects their time and has accurately managed their data.

In a number of embodiments, the second written consent form screen 630 may also include a section outlining the specific terms and options for which consent is requested, such as receiving marketing messages, service updates, or other communications. Each consent option can be displayed with a brief, understandable description, accompanied by easy-to-use checkboxes or toggle switches that the consumer can select based on their preferences. Any regulatory or legal language, such as privacy disclosures or details about how their information will be used, may be presented in a clear, accessible format, ensuring that the consumer understands the implications of their consent. By keeping the process concise and straightforward, the form can enhance transparency and empowers the consumer to make an informed decision about their communication preferences, fostering trust and reinforcing a positive, user-centered experience.

Finally, a third written consent form screen 640 on the consumer's mobile device can provide a streamlined and informative layout, guiding them through the details of the consent request with clarity. After reviewing pre-filled fields, such as their name, phone number, and email address, the consumer can easily scroll down to a section outlining the terms of consent. Each consent option is presented with a short, clear description, ensuring the consumer understands what they are agreeing to, whether it's receiving updates, promotional messages, or important notifications. At the bottom of the screen, a prominent “I Accept” button (or similar text) is positioned for easy access, encouraging a final review before consent submission. This button can be designed with bold, visually distinct colors to make it stand out, signaling the action required. By tapping this button, the consumer finalizes their consent, allowing them to confidently proceed with the understanding that their preferences have been clearly recorded.

Although specific embodiments for prior express written consent form delivery suitable for carrying out the various steps, processes, methods, and operations described herein is discussed with respect to FIGS. 6A and 6B, any of a variety of systems and/or processes may be utilized in accordance with embodiments of the disclosure. For example, the exact layout of the consent form can vary, depending on the device being utilized, such as on a desktop computer, tablet device, wearable, etc. The elements depicted in FIGS. 6A and 6B may also be interchangeable with other elements of FIGS. 1-5 and 7-10 as required to realize a particularly desired embodiment.

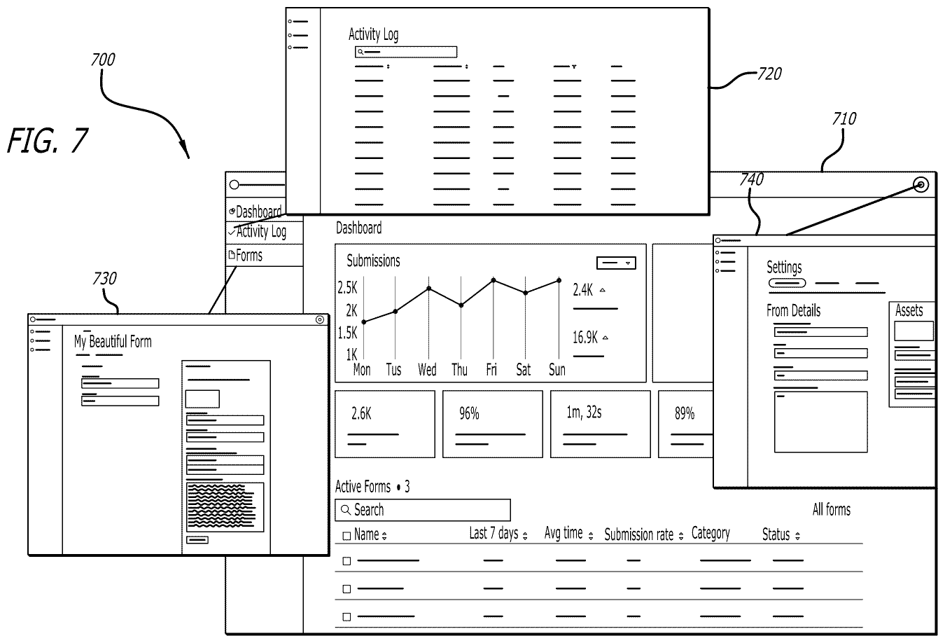

Referring to FIG. 7, a conceptual illustration of a plurality of reporting screens 700 in accordance with various embodiments of the disclosure is shown. The dashboard 710 can serve as a central hub where clients can access and monitor a comprehensive overview of their consent capture activities, featuring interactive links to essential tools such as the activity log 720, customized form creation tool 730, and settings view 740. In the dashboard 710, clients may find an array of visually engaging charts and graphs that illustrate key metrics, including trends in consent acquisition, opt-out rates, and daily or monthly engagement statistics. These visualizations can provide at-a-glance insights into consumer behavior and consent patterns, making it easy for clients to assess the effectiveness of their outreach and compliance efforts. Below the charts, the dashboard 710 might display a summary of metrics, such as total consents obtained, pending responses, and the percentage of consumers who have opted in for various communication types, etc.

Additionally, the dashboard 710 can include a dynamic list of recent form records, allowing clients to quickly review the latest consent submissions with details like timestamps, contact information, and form types. Clients can click on individual records for further details or to initiate actions, such as sending follow-up messages. With accessible links to the activity log, clients can view a chronological history of actions taken within the system, including updates to consent records and modifications to forms, supporting transparency and accountability.

In many embodiments, the activity log 720 can offer a detailed, chronological record of actions taken within the consent capture system, providing clients with a clear history of interactions for transparency, compliance, and auditing purposes. Each entry in the log may include essential information such as the timestamp, action type, user responsible, and relevant details about the event, like modifications to consent forms, consent submissions, or updates to client settings. To enhance usability, the activity log 720 may be organized in an interactive table format with options to filter by date range, action type, or user, allowing clients to focus on specific events or periods as needed. For example, a client can view only recent consent submissions or filter for form modifications within the last month. This log may also incorporate icons or color coding to differentiate between routine actions and critical updates, making it easier to scan for relevant information.

In a number of embodiments, the customized form creation tool 730 can be a flexible, user-friendly interface that enables clients to design, modify, and deploy consent forms tailored to their specific needs. Various embodiments can include a drag-and-drop layout where clients can add essential elements like text fields, checkboxes, dropdowns, and signature lines, allowing them to build forms that collect exactly the data required while remaining compliant with legal standards. Branding elements such as logos, color schemes, and font choices can also be applied, ensuring that each form aligns with the client's identity and offers a seamless experience for consumers. To support compliance, the tool may include a library of pre-configured legal disclosures that clients can easily incorporate based on their industry or region, such as General Data Protection Regulation (GDPR) or Telephone Consumer Protection Act (TCPA) disclosures. A live preview function may allow clients to see how the form will appear on various devices, from mobile phones to desktops, ensuring a responsive and accessible design.

In more embodiments, the settings view 740 provides clients with a centralized area to configure and manage key aspects of the consent capture system, enabling them to align the system with their specific operational and compliance requirements. Various embodiments can be organized into sections, the settings view 740 may offer options to adjust user permissions, allowing clients to define access levels for different team members to enhance security and accountability. Data retention preferences can be set to define how long consent records are stored, supporting compliance with privacy regulations such as the California Consumer Privacy Act (CCPA) or GDPR. Notification settings can allow clients to choose how frequently they receive updates on system activities or consumer interactions, enabling them to stay informed without being overwhelmed by notifications. The settings view 740 may also include integration options, allowing clients to connect the system with external platforms like customer relationship management (CRM) software or analytics tools for a seamless data flow.

Although a specific embodiment for a plurality of reporting screens suitable for carrying out the various steps, processes, methods, and operations described herein is discussed with respect to FIG. 7, any of a variety of systems and/or processes may be utilized in accordance with embodiments of the disclosure. For example, the specific look and layout of the dashboard 710 and associated views can vary based on a number of factors such as the type of device being viewed on, the features enabled within a specific deployment, etc. The elements depicted in FIG. 7 may also be interchangeable with other elements of FIGS. 1-6B and 8-10 as required to realize a particularly desired embodiment.

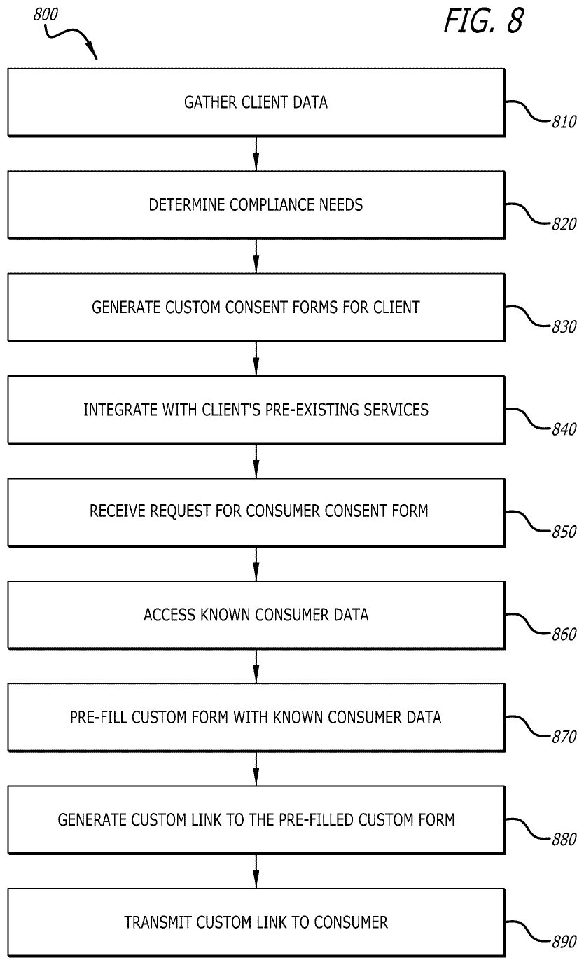

Referring to FIG. 8, a process 800 for transmitting a prior express written consent form to a consumer in accordance with various embodiments of the disclosure is shown. In many embodiments, the process 800 can gather client data (block 810). In some embodiments, this may involve collecting and organizing the necessary information from the client (the business seeking to gain consumer consent) to ensure that the consent capture process aligns with their specific needs and regulatory obligations. This data-gathering phase can include retrieving the client's branding elements, such as logos, color schemes, and specific wording preferences, which will be used to create a customized consent form that reflects the client's identity and enhances consumer trust. Additionally, the process 800 may gather information about the types of communications for which the client requires consent, such as marketing emails, SMS messages, or phone calls, and any specific regulatory requirements they must meet based on their industry, location, or audience demographics. Furthermore, the client data may include segmentation criteria, enabling the system to adjust consent requests for different customer groups, such as tailoring language for specific regions or adapting opt-in choices based on age groups or consumer preferences.

In more embodiments, the process 800 can determine compliance needs (block 820). In certain embodiments, the process 800 can analyze the specific legal and regulatory requirements the client must adhere to in order to ensure that their consent capture efforts meet all necessary standards. In some embodiments, the process 800 can assess the client's industry, target audience, and geographic location, as different regions and sectors may be subject to varying consent regulations, such as the Telephone Consumer Protection Act (TCPA) in the United States, the General Data Protection Regulation (GDPR) in the European Union, or the California Consumer Privacy Act (CCPA). This may also involve reviewing any industry-specific regulations the client must follow, such as additional privacy guidelines in financial, healthcare, or education sectors, where consumer information is highly sensitive. Various embodiments of the process 800 can analyze and compile the necessary language, disclosures, and consent options that must be included in the consent form to satisfy these regulatory needs, ensuring that consumers are fully informed before agreeing to be contacted. This stage may also define the requirements for record-keeping, such as which types of metadata (e.g., timestamps, IP addresses, and device information) must be captured to create a verifiable record of consent. Additionally, the process 800 may set parameters for consent expiration dates, renewal intervals, and data retention periods based on regulatory guidelines, which will later influence how consent is managed and tracked over time.

In a number of embodiments, the process 800 can generate custom consent forms for clients (block 830). In some embodiments, the process 800 can create tailored consent forms that reflect the client's branding and meet their specific compliance and communication needs. At this stage, the process 800 can apply branding elements such as logos, color schemes, and font styles to ensure that the form aligns visually with the client's identity and provides a cohesive experience for consumers. Various embodiments of the process 800 may also use the compliance requirements to incorporate the necessary legal language, disclosures, and consent options that consumers must review and agree to. This can include outlining the types of communications the client intends to send, such as marketing messages, service updates, or promotions, and providing checkboxes or dropdowns that allow consumers to opt in to specific categories as required by law. To further enhance the consumer experience, the form may include user-friendly elements, such as tooltips or links to privacy policies, which clarify any legal or compliance-related terms.

In further embodiments, the process 800 can integrate with client's pre-existing services (block 840). In some embodiments, the process 800 can include connecting a consent capture system with the client's existing tools, platforms, and databases to ensure a cohesive workflow and enable real-time data synchronization. This integration can include linking the consent capture system with the client's customer relationship management (CRM) software, allowing customer consent statuses and preferences to be immediately updated across both systems. Additionally, the system may connect with any marketing automation platforms or communication tools the client uses, such as email services, SMS providers, or call center software, to enable seamless consent-based outreach. If the client has record hygiene systems in place, such as do-not-call (DNC) lists or opt-out databases, the integration may incorporate these resources to automatically filter out individuals who should not be contacted, ensuring compliance at every stage. In cases where the client relies on external verification services or data storage solutions, the integration may include secure data transfer protocols to ensure that consent records are stored and accessible in line with company policies and regulatory requirements.

In additional embodiments, the process 800 can receive a request for a customer consent form (block 850). In some embodiments, the process 800 may process a request initiated by the client or triggered by an automated workflow to send a customized consent form to a specific consumer. This request can originate from various points within the client's operations, such as a marketing campaign launch, a customer service interaction, or an automated re-verification process. When the request is received, the system may identify the relevant consumer data, including the contact details and any applicable consent history, ensuring that the form generated reflects the most accurate and up-to-date information. The request may also specify the communication channel through which the form should be sent, such as via email, SMS, or an in-app notification, depending on the consumer's preferences or the client's outreach strategy.

In still more embodiments, the process 800 can access known customer data (block 860). In various embodiments, the process 800 can retrieve and verify all relevant information about the consumer from the client's databases or integrated systems to ensure that the consent form is properly customized and aligned with the consumer's existing preferences and records. This step can pull from various data sources, including customer relationship management (CRM) software, marketing databases, or past interactions stored within the consent capture system. The retrieved consumer data may include personal details such as the consumer's name, email address, phone number, and any prior communication preferences or consent history. This data can be used to pre-fill certain fields in the consent form, making the process more efficient for the consumer and reducing the risk of errors during form completion. In certain embodiments, the process 800 may also review any consent records previously associated with the consumer to ensure that the new consent request does not conflict with any existing opt-outs or legal restrictions, such as being listed on a do-not-call (DNC) list. Furthermore, the consumer data accessed at this stage may include information relevant to segmentation, such as demographic data, geographic location, or preferred communication methods, which can influence how the consent form is presented, or which regulatory requirements need to be included.

In yet further embodiments, the process 800 can pre-fill a custom form with known customer data (block 870). In certain embodiments, the process 800 can involve automatically populating specific fields within the consent form using information already available about the consumer, which was retrieved in the previous step. This can streamline the process for the consumer by reducing the amount of manual entry required, thereby increasing the likelihood that they will complete the form. The data used to pre-fill the form may include basic personal details, such as the consumer's name, email address, phone number, and mailing address, as well as other relevant information, such as their preferred communication channels or any prior consent preferences they have expressed. By utilizing known consumer data, the form can provide a more personalized experience, allowing the consumer to simply review the information rather than having to enter it again. Some embodiments of the process 800 may also ensure that any pre-filled data adheres to regulatory requirements and privacy standards, such as not displaying certain sensitive information unless necessary and permissible under laws like the General Data Protection Regulation (GDPR) or California Consumer Privacy Act (CCPA). Additionally, the pre-fill process may incorporate segmentation data, so the form reflects details relevant to the consumer's specific demographic or geographic region. This step helps to eliminate friction in the user experience by minimizing the time and effort required from the consumer while ensuring accuracy and consistency in the data presented.

In numerous embodiments, the process 800 can generate a custom link to the pre-filled custom form (block 880). Various embodiments of the process 800 may involve creating a unique, secure URL that directs the consumer to their personalized consent form. This custom link can be generated by the system based on the specific parameters of the consent request, ensuring that it leads the consumer to the correct, pre-filled form containing all relevant data retrieved and populated in previous steps. The custom link may be encoded with encrypted identifiers to securely tie it to the consumer's unique record, safeguarding any personal information embedded within the form and ensuring that only the intended recipient can access it. The system may also assign an expiration timeframe to the link for additional security, restricting access after a certain period to prevent unauthorized use. This link generation may also involve tagging the URL with tracking data, allowing the system to monitor when the link is accessed, the type of device used, and other engagement metrics that can provide insight into consumer interaction with the consent request. The custom link may also be optimized for delivery through multiple channels, such as SMS, email, or in-app notifications, to ensure that it can be accessed easily from a range of devices, including smartphones, tablets, and desktops.

In more additional embodiments, the process 800 can transmit a custom link to the consumer (block 890). In some embodiments, the process 800 can deliver the unique link to the pre-filled consent form through the consumer's preferred communication channel, ensuring a direct, accessible pathway for them to review and complete their consent. This can involve selecting the most effective and compliant method of transmission, whether via SMS, email, or an in-app notification, based on the consumer's preferences or any prior communication agreements. The system may handle the personalization of this message by incorporating the consumer's name, a brief overview of the purpose of the consent form, and instructions for accessing and completing it. Additionally, the transmission may include a summary of what the consumer can expect upon clicking the link, offering clarity and reinforcing trust in the process. For security and tracking, some embodiments of the process 800 may log the transmission details, such as the timestamp, channel used, and any initial engagement metrics, which can provide insight into when the consumer received the link and if further follow-up may be needed. The message may also be optimized for mobile-friendly display, ensuring that the link is easily clickable and viewable across different devices, whether accessed on a smartphone, tablet, or desktop.

Although a specific embodiment for a process 800 for transmitting a prior express written consent form to a consumer suitable for carrying out the various steps, processes, methods, and operations described herein is discussed with respect to FIG. 8, any of a variety of systems and/or processes may be utilized in accordance with embodiments of the disclosure. For example, one or more of these steps may be optional or otherwise occur in a different order based on the application desired and deployment being utilized. The elements depicted in FIG. 8 may also be interchangeable with other elements of FIGS. 1-7 and 9-10 as required to realize a particularly desired embodiment.

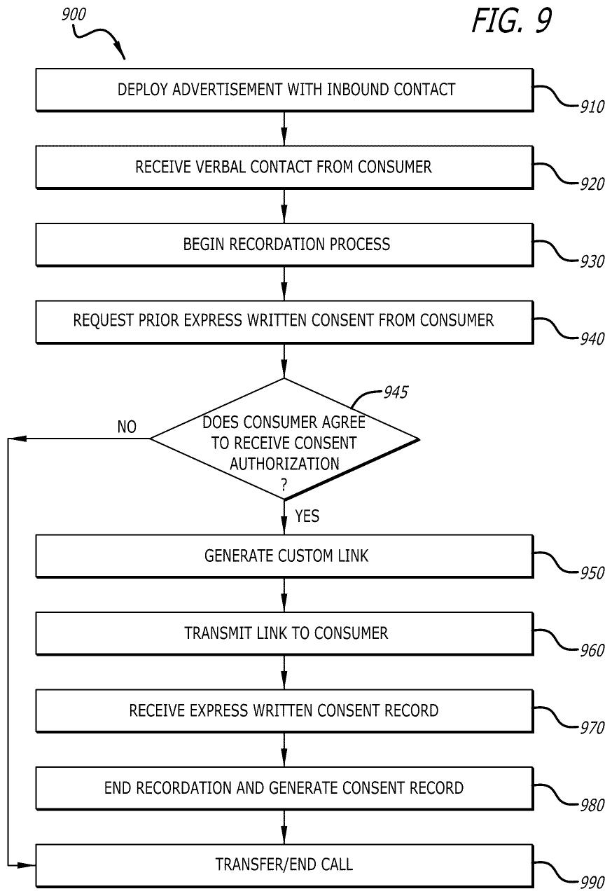

Referring to FIG. 9, a process 900 for capturing prior express written consent in accordance with various embodiments of the disclosure is shown. In many embodiments, the process 900 can deploy an advertisement with at least one inbound contact (block 910). In some embodiments, the process 900 can involve creating and distributing an advertisement that encourages consumers to initiate contact with the client for more information or services, serving as a starting point for capturing prior express written consent. This advertisement can be carefully crafted to provide clear, enticing messaging that communicates the value of reaching out, whether through a dedicated phone number, website, or mobile app that allows for inbound consumer inquiries. The advertisement may include information about the client's offerings, potential benefits to the consumer, and, where legally required, a brief notice about the use of their contact information and the opportunity to authorize communications. The medium of the advertisement can vary depending on the target audience and may include channels like social media, search engine ads, TV or radio spots, or print materials, each designed to generate interest and drive inbound contact from consumers. Some embodiments of the process 900 may track when and where the advertisement is deployed, noting engagement metrics such as views, clicks, or calls, to gauge its effectiveness and adjust future outreach strategies. By prompting the consumer to initiate contact, the advertisement not only captures interest but also establishes a foundation for a compliant consent process by providing transparency upfront.

In a number of embodiments, the process 900 can receive a verbal contact from the consumer (block 920). In certain embodiments, the process 900 can involve the consumer reaching out directly in response to an inbound contact advertisement, such as calling a phone number listed in a social media ad, search engine result, or other promotional material. This initial verbal contact marks the start of the consent capture process, as the consumer actively engages with the client's advertisement to request more information or inquire about a service. The representative may also introduce the next steps in the process.

In more embodiments, the process 900 can begin a recordation process (block 930). In some embodiments, the process 900 can involve initiating an audio recording of the call with the consumer, documenting their verbal agreement to receive further communications and creating a verifiable record that can be used to generate prior express written consent. This recording process can start immediately after the representative informs the consumer that the call will be recorded for compliance and verification purposes, ensuring transparency and aligning with legal requirements for consent documentation. Various embodiments of the process 900 may automatically generate a timestamp at the start of the recording, capturing the exact date and time, which can later serve as essential evidence should verification of the consent details be required. During this, the recording may capture the representative's clear, scripted explanation of the nature and purpose of the consent being obtained, including specifics about the types of communications the consumer is agreeing to receive. The consumer's affirmative responses can also be recorded, confirming their understanding and agreement to participate. The recordation process can be configured to adhere to one or more data protection standards such as the General Data Protection Regulation (GDPR) and California Consumer Privacy Act (CCPA). Additionally, the system may be configured to tag specific parts of the recording, marking points where the consumer verbally provides consent, to facilitate easy retrieval and reference.

In further embodiments, the process 900 can request prior express written consent from the consumer (block 940). Some embodiments of the process 900 may involve the representative clearly explaining to the consumer that, beyond their verbal consent, they are now being asked to provide prior express written consent to receive specific communications. This step is often required when ensuring compliance with regulations such as the Telephone Consumer Protection Act (TCPA). The representative may guide the consumer through the purpose of this written consent, explaining that it will allow the client to send them communications via channels such as SMS, phone calls, or emails, depending on the consumer's preferences and the consent terms. During this interaction, the representative may confirm that the consumer fully understands the types of messages they are agreeing to receive, clarifying any terms and addressing questions the consumer may have to ensure transparency. The representative might also inform the consumer that this written consent can be withdrawn at any time, reinforcing that they retain control over their communication preferences.

In various embodiments, the process 900 can determine if the consumer agrees to receive consent authorization (block 945). In some embodiments, the process 900 may involve the representative confirming that the consumer is willing to proceed with the consent process, specifically by receiving a custom link to formally authorize consent in writing. During this step, the representative may ask a direct question to gauge the consumer's interest and readiness. This can ensure that the consumer is comfortable with the process and understands what will happen next.

If the consumer does not agree to receive consent authorization, the process 900 can transfer or otherwise end the call (block 990). However, if the consumer agrees to receive a consent authorization, then some embodiments of the process 900 can generate a custom link (block 950). Various embodiments of this process may involve creating a unique, secure URL specifically tailored to the individual consumer, which will lead them to the consent authorization form. This custom link can be generated by the system based on the consumer's details gathered earlier in the process, ensuring it is tied directly to their unique record and that only they can access it. The system may encode the link with encrypted identifiers, linking it to the consumer's contact information and maintaining privacy and security throughout the consent process. Additionally, the custom link may contain metadata or tracking tags that allow the system to log when the link is accessed, providing valuable engagement data without compromising consumer privacy. This generation process may also include setting parameters for link expiration, ensuring that it remains active for only a limited period to prevent unauthorized access or accidental use outside the intended timeframe. The link itself may be optimized for delivery across various channels, such as SMS, email, or an in-app message, allowing it to adapt seamlessly to the consumer's preferred communication method.

In additional embodiments, the process 900 can transmit the custom link to the consumer (block 960). In some embodiments, the process 900 can involve securely delivering the custom link to the consumer through their preferred communication channel, ensuring it is both accessible and convenient for them to review and complete the consent process. This transmission may occur via SMS, email, or in-app messaging, depending on the consumer's indicated preferences or prior interactions with the client. To enhance security and reliability, the system may log the details of the transmission, including the exact timestamp, delivery status, and channel used, creating a traceable record for compliance purposes. In cases where the transmission is sent via SMS or email, the message content may be optimized for easy readability on mobile devices, ensuring that the link is easily clickable, and the instructions are straightforward. Additionally, the system may be configured to resend the link if it detects that the consumer has not accessed it within a specified timeframe, providing a gentle reminder to complete the consent process without overwhelming the consumer.

In still more embodiments, the process 900 can receive an express written consent record (block 970). In certain embodiments, the process 900 can involve capturing and securely storing the consumer's completed consent form after they access the custom link and formally agree to receive specific communications. Upon submission of the form, the system can create a digital record that includes all necessary details to verify compliance, such as a timestamp marking the exact date and time the consent was given, the method of consent (e.g., SMS or email link), and any identifying information linked to the consumer's authorization. This record may include metadata from the consumer's interaction, such as the device used, IP address, and geographic location, all of which can help validate the authenticity of the consent. Numerous embodiments of the process 900 may immediately log this express written consent into a secure database, ensuring it is accessible for future verification while adhering to data privacy regulations like the General Data Protection Regulation (GDPR) or California Consumer Privacy Act (CCPA). By tagging the record with identifiers that link it directly to the consumer's profile in the customer relationship management (CRM) system, this ensures that all subsequent communications are based on a clear, documented record of consent. The express written consent record may be flagged for easy retrieval in case of audits or consumer inquiries, providing a transparent, traceable history of the consumer's agreement.

In yet further embodiments, the process 900 can end the recordation and generate a consent record (block 980). Some embodiments of the process 900 may involve finalizing the documentation of the consumer's consent interaction and securely storing it as a complete record within the system. Once the consumer has submitted the consent form, the system may end the recording process, if applicable, by stopping the audio or video capture of the consent confirmation or other parts of the call where consent was discussed. This step can involve automatically tagging the end of the recordation with a timestamp and other relevant details, such as the length of the interaction and the specific method by which consent was obtained. This final record may include both the written consent form, and any verbal confirmations previously provided, creating a comprehensive consent record that demonstrates full compliance with regulations like the Telephone Consumer Protection Act (TCPA) or the General Data Protection Regulation (GDPR). This consent record may be encrypted and assigned a unique identifier that links it directly to the consumer's profile, ensuring easy retrieval for audits, compliance checks, or customer service inquiries. The system may also flag this record as “finalized” to indicate that the consumer has given full authorization, preventing any further prompts or unnecessary requests for consent.

In more additional embodiments, the process 900 can transfer or otherwise end the call (block 990). After the consent record has been finalized, the representative may either seamlessly transfer the call back to the client for any additional services or inquiries the consumer wishes to address, or courteously end the call if no further action is needed. The representative can confirm that all necessary steps for consent have been completed and thank the consumer for their time, ensuring a positive and professional closure to the interaction. This handoff or call conclusion allows the client to transition smoothly from the consent process to their primary engagement with the consumer, reinforcing trust and satisfaction.

Although a specific embodiment for a process 900 for capturing prior express written consent suitable for carrying out the various steps, processes, methods, and operations described herein is discussed with respect to FIG. 9, any of a variety of systems and/or processes may be utilized in accordance with embodiments of the disclosure. For example, the recordation data may be packaged in such a way that it is tamper-proof after recordation which can be utilized to verify the authenticity of the recordation at a later time. The elements depicted in FIG. 9 may also be interchangeable with other elements of FIGS. 1-8 and 10 as required to realize a particularly desired embodiment.

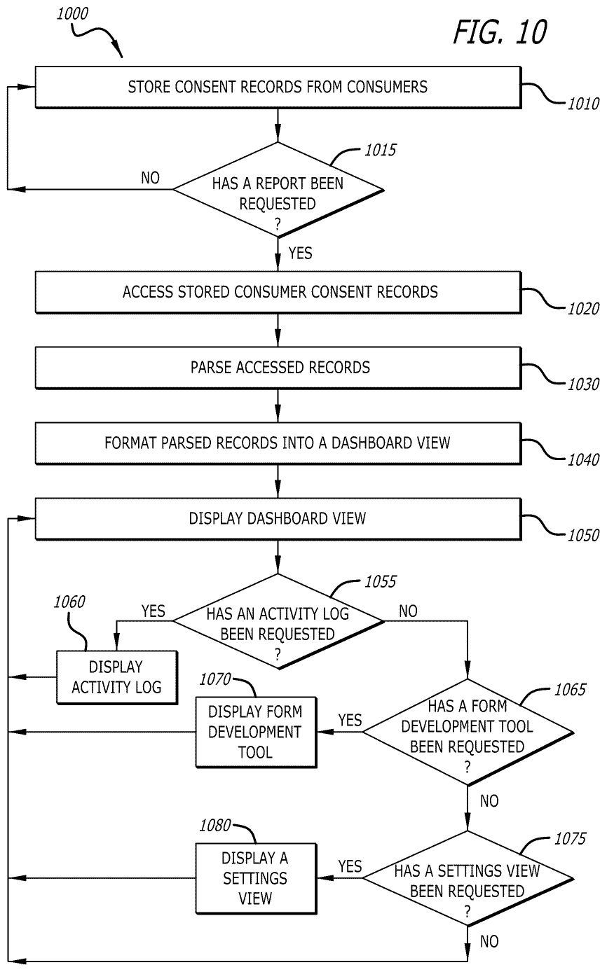

Referring to FIG. 10, a process for providing records from a consumer content capture system in accordance with various embodiments of the disclosure is shown. In many embodiments, the process 1000 can store various consent records from consumers (block 1010). In some embodiments, the process 1000 may involve storing various consent records from consumers in a secure, organized database, ensuring that all details of each consent interaction are properly documented and readily accessible. Each record stored may include essential information, such as the type of consent provided (e.g., for marketing communications or service updates), the date and time the consent was given, and any identifying metadata, like device information or IP address, that helps authenticate the record. These records may be tagged with unique identifiers linked to individual consumer profiles, allowing for easy retrieval and cross-referencing when needed. To comply with regulatory standards like the General Data Protection Regulation (GDPR) or the California Consumer Privacy Act (CCPA), the system may employ encryption and access controls to protect sensitive information, ensuring only authorized personnel can view or interact with the stored records.

In more embodiments, the process 1000 can determine if a report has been requested (block 1015). This determination can occur through a client's direct action within the system interface, such as clicking on a reporting option or setting a scheduled time for automated report generation. If a report has not been requested, the process 1000 can continue to store consent records from consumers (block 1010). However, if it is determined that a report has been requested, the process 1000 can access stored consumer consent records (block 1020). In some embodiments, the process 1000 can involve the system retrieving relevant data from the centralized repository of consent records, selecting entries that match the specific parameters of the client's report request. This step can require filtering through the stored records based on criteria such as date range, consent type (e.g., marketing, service updates), or consumer demographics, depending on the level of detail the client requires. The system may also cross-reference the client's permissions to ensure that only authorized records are accessed, safeguarding sensitive information and adhering to privacy regulations like the General Data Protection Regulation (GDPR) or the California Consumer Privacy Act (CCPA).

In a number of embodiments, the process 1000 can parse the access records (block 1030). In various embodiments, the process 1000 may involve the system analyzing the retrieved consent data to organize and categorize it according to the client's reporting needs. This parsing can involve examining each accessed consent record in detail, extracting key data points such as consent type, timestamp, consumer location, contact method, and any relevant metadata, like device information or IP address. Parsing may also involve filtering out any records that don't meet the specific criteria set in the report request, ensuring that the final output includes only the most pertinent information. For instance, if the client requested a report on marketing consent given in the past month, the system would exclude records related to service updates or records outside that timeframe, streamlining the data set for relevance and accuracy.

In further embodiments, the process 1000 can format the parsed records into a dashboard view (block 1040). In some embodiments, the process 1000 can involve transforming the organized consent data into a visual, interactive layout that allows clients to easily interpret and analyze the information. This formatting process can include structuring the parsed data into various visual elements such as charts, graphs, tables, and summary metrics that capture key insights at a glance. For example, the system may generate line graphs to show trends in consent capture over time, pie charts to illustrate the distribution of consent types (e.g., marketing vs. service updates), and data tables for more granular details like individual consent timestamps or geographic locations. The dashboard view can be designed to provide both high-level summaries and drill-down options, enabling clients to toggle between overall trends and specific data points based on their reporting needs. To enhance usability, the dashboard may incorporate filters, drop-down menus, and search functionality, allowing clients to further refine the data displayed by adjusting parameters such as date ranges, consent categories, or consumer demographics. Additionally, the dashboard format may include color coding and icons to help differentiate data types, highlight trends, or flag areas that require attention, such as spikes in opt-outs or a decline in certain consent types.

In additional embodiments, the process 1000 can display the dashboard view (block 1050). In various embodiments, the process 1000 may involve presenting the formatted, interactive dashboard directly to the client within the consent capture system's user interface, allowing for immediate access to key metrics and insights related to consumer consent activity. Once displayed, the dashboard can serve as a central hub where clients can monitor consent trends, review detailed data, and track compliance status in real-time. The dashboard may be designed to automatically update as new consent records are captured, ensuring that the data presented remains current and reflective of ongoing consumer interactions. Display elements like charts, graphs, and summary metrics may be prominently positioned, providing clients with an at-a-glance overview of their consent data, such as monthly consent rates, consumer preferences for specific communication channels, or geographic breakdowns of consent responses. The display may also incorporate performance indicators, such as consent compliance percentages or opt-out rates, allowing clients to quickly gauge the effectiveness and compliance level of their consent capture efforts.

In still more embodiments, the process 1000 can determine if an activity log has been requested (block 1055). In some embodiments, the process 1000 may involve the system monitoring user interactions within the dashboard to detect when the client selects the option to view the activity log. This step can be triggered by the client clicking an icon, selecting a menu option, or using a shortcut that indicates their intent to review a detailed record of system activities. Upon detecting this request, the system may assess the client's access permissions, ensuring they have the authorization needed to view sensitive or restricted activity information.

If it is determined that an activity log has been requested, various embodiments of the process 1000 can display an activity log (block 1060). In some embodiments, the process 1000 may involve presenting a comprehensive, organized view of recorded actions within the consent capture system, allowing the client to review detailed information about each significant event. Once the system has processed the request, it can present the activity log in a user-friendly layout, typically structured as a chronological list or table. This display may include key details for each logged action, such as the timestamp of the event, the specific type of action taken (e.g., consent submission, form modification, or settings adjustment), the user responsible for the action, and any relevant notes or descriptions that add context to the entry. To further enhance readability, the log may incorporate filters, allowing the client to refine their view by criteria such as date range, action type, or user role, ensuring they can quickly locate specific events or focus on particular aspects of system activity. The log display may also support interactive elements, enabling clients to expand individual entries to view additional details or to collapse them for a more streamlined overview. Color-coding or icons might be used to differentiate between types of actions, helping users visually identify patterns or critical entries, such as high-impact changes or unusual login activities. In some cases, the activity log could include export options, enabling clients to download the data for offline review or documentation purposes, especially useful for audits or compliance reporting.

However, if it is determined that an activity log has not been requested, various embodiments of the process 1000 can further determine if a form development tool has been requested (block 1065). This step can be triggered by the client clicking an icon, selecting a menu option, or using a shortcut that indicates their intent to review a consent form development tool such as the one depicted in FIG. 5. Upon detecting this request, various embodiments of the process 1000 may assess the client's access permissions, ensuring they have the authorization needed to view sensitive or restricted activity information.

If it is determined that a form development tool has been requested, various embodiments of the process 1000 can display a form development tool (block 1070). In certain embodiments, the process 1000 may involve presenting an interactive, user-friendly interface that allows clients to create, customize, and refine consent forms according to their specific needs and branding requirements. Once accessed, the form development tool can provide a range of design options, such as drag-and-drop functionality for adding elements like text fields, checkboxes, dropdown menus, and signature boxes. The tool may offer pre-built templates to help clients quickly start with a compliant structure or allow them to design a form from scratch to meet unique requirements. Each form element may be customizable, enabling users to edit labels, adjust placement, or add instructional text to ensure clarity for consumers. Additionally, the tool can include branding features, letting clients upload logos, set colors, and apply custom fonts so that each form aligns with their brand identity.

To further enhance usability, the form development tool may offer a live preview mode, allowing clients to see how the form will appear across different devices, such as smartphones, tablets, and desktops, ensuring a responsive and user-friendly experience for consumers. The tool may also include options for embedding legal language and regulatory disclosures, automatically pulling in compliance-specific text based on the client's location or industry, which helps streamline adherence to regulations like the Telephone Consumer Protection Act (TCPA) or General Data Protection Regulation (GDPR). Once the form is displayed in the development tool, clients may have access to additional settings, such as setting form expiration dates, activating automated notifications upon form submission, or configuring custom confirmation messages.

However, if it is determined that a setting has not been requested, numerous embodiments of the process 1000 can further determine if a settings view has been requested (block 1075). This step can be triggered by the client clicking an icon, selecting a menu option, or using a shortcut that indicates their intent to review a settings view. Upon detecting this request, various embodiments of the process 1000 may assess the client's access permissions, ensuring they have the authorization needed to view sensitive or restricted activity information.

If it is determined that settings tool has been requested, certain embodiments of the process 1000 can display a settings view (block 1080). In various embodiments, the process 1000 may involve presenting a centralized, customizable interface where clients can manage and configure various aspects of the consent capture system to align with their operational and compliance requirements. This settings view may be organized into intuitive sections, such as user permissions, data storage preferences, notification preferences, and integration options, allowing clients to easily navigate and adjust settings based on their specific needs. Within the user permissions area, for example, clients can assign different levels of access to team members, enabling fine-grained control over who can view, edit, or manage consent records and form development tools. Data storage settings might allow clients to define retention periods for consent records, ensuring compliance with regulations like the General Data Protection Regulation (GDPR) or California Consumer Privacy Act (CCPA) by automatically archiving or deleting data as needed.

In more embodiments, the settings view may provide options for customizing notifications, allowing clients to choose how and when they receive alerts about consumer interactions, consent form submissions, or system updates. Integration settings may also be accessible here, enabling clients to connect the consent capture system with external platforms such as customer relationship management (CRM) systems, communication tools, or analytics software, creating a seamless flow of data across their ecosystem. To support compliance, the settings view might include options for configuring legal disclaimers, privacy notices, and other regulatory language that appears on consumer-facing forms. By displaying a comprehensive, user-friendly settings view, the system empowers clients to tailor the consent capture environment to their operational workflows, enhancing control, efficiency, and regulatory alignment across all aspects of consent management.

In various embodiments, the process 1000 can return to displaying a dashboard view (block 1050). This process can repeat until exiting the reporting tool. Those skilled in the art will recognize that the selection of different logs, tools, and views can occur in any order as desired by the user.

Although a specific embodiment for a process 1000 for providing records from a consumer content capture system suitable for carrying out the various steps, processes, methods, and operations described herein is discussed with respect to FIG. 10, any of a variety of systems and/or processes may be utilized in accordance with embodiments of the disclosure. For example, the process 1000 described herein is exemplary and any other views, logs, and tools can be added or removed from the process depend on the options of the system specifically deployed. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A device, comprising:
a processor;
a memory communicatively coupled to the processor; and
a consent capture logic configured to:
receive a request for a consumer consent capture;
record verbal consent from consumer;
generate a custom link;
transmit a message to the consumer, wherein the message incorporates at least the customized link;
receive consent form data associated with the consumer; and
generate consent record data.

2. The device of claim 1, wherein the message is a text message.

3. The device of claim 1, wherein the consent capture logic is further configured to store the consent record data.

4. The device of claim 3, wherein the consent record data further includes at least the verbal consent recording.

5. The device of claim 1, wherein the custom link is configured to direct the consumer to a consent form.

6. The device of claim 5, wherein the consent form is associated with a client requesting consent from the consumer.

7. The device of claim 6, wherein the consent form is bespoke for the client.

8. The device of claim 7, wherein the bespoke consent form includes at least client branding.

9. The device of claim 6, wherein the consent capture logic is further configured to transmit the consent record data to the client.

10. The device of claim 1, wherein the request for the consumer consent capture is received from a customer relationship management software.

11. The device of claim 1, wherein the consent record data is configured as prior express written consent.

12. The device of claim 11, wherein the prior express written consent is formatted to comply with one or more legal requirements.

13. The device of claim 12, wherein the one or more legal requirements includes at least the Telephone Consumer Protection Act.

14. A method of providing customized consent forms, comprising:
gathering client data;
determining one or more compliance requirements;
parsing the client data for at least client branding;
generating at least one bespoke consent form utilizing the client branding and comprising a plurality of input fields;
receiving a request for consumer consent capture;
determining at least one input field of the plurality of input fields that can be pre-filled;
transmitting a custom link to access the bespoke consent form;
receiving a request for delivery of the bespoke consent form; and
rendering the bespoke consent form with at least one pre-filled field.

15. The method of claim 14, wherein the request for consumer consent capture comprises at least consumer data.

16. The method of claim 14, wherein the at least one input field is determined by parsing the consumer data.

17. The method of claim 14, wherein custom link is configured with at least one identifier to indicate association with a particular consumer.

18. The method of claim 14, wherein the rendering of the bespoke consent form is transmitted over a network.

19. The method of claim 15, wherein the client branding includes at least a client logo.

20. A method of capturing consent, comprising:
receiving a request for a consumer consent capture;
recording verbal consent from consumer;
generating a custom link;
transmitting a message to the consumer, wherein the message incorporates at least the customized link;
receiving consent form data associated with the consumer; and
generating consent record data.
